(19) United States
(12) Patent Application Publication
(10) Pub. No.: US 2026/0364519 A1
(43) Pub. Date: Nov. 19, 2026

(54) ACTIVE CARBON CAPTURE SYSTEM WITH A DISTRIBUTED CONTROL ARCHITECTURE AND METHODS OF CONTROL

(71) Applicant: Provocative Science Holdings, Inc., Somerville, MA (US)

(72) Inventors: Nicholas Meyer, Boston, MA (US); Indrid Xhuti, Watertown, MA (US); Andrew Bouma, Cambridge, MA (US)

(73) Assignee: Provocative Science Holdings, Inc., Somerville, MA (US)

(21) Appl. No.: 19/674,696

(22) Filed: May 12, 2026

Related U.S. Application Data
(60) Provisional application No. 63/804,193, filed on May 12, 2025.

(51) Int. Cl. B01D 53/04

(52) U.S. Cl. CPC B01D 53/0454; B01D 53/0438; B01D 53/0446; B01D 2257/504

(57) ABSTRACT

An active carbon capture system with a distributed control architecture and methods of control. The system includes at least a system component configured to receive a control signal and perform a carbon capture action as a function of the control signal; at least a first level control circuit communicatively connected to the at least one system component, the at least a first level control circuit configured to receive a command signal and transmit the control signal to the at least one system component as a function of the command signal; and at least a unit controller communicatively connected to the at least a first level control circuit, the at least a unit controller configured to detect at least a system parameter, generate the command signal as a function of the at least a system parameter, and transmit the command signal to the at least a first level control circuit.

### CROSS-REFERENCE TO RELATED APPLICATIONS

This application claims the benefit of priority of U.S. Provisional Patent Application Ser. No. 63/804,193, filed on May 12, 2025, and titled “ACTIVE CARBON CAPTURE SYSTEM WITH A DISTRIBUTED CONTROL ARCHITECTURE,” which is incorporated by reference herein in its entirety.

### FIELD OF THE INVENTION

The present invention generally relates to the field of carbon capture. In particular, the present invention is directed to an active carbon capture system with a distributed control architecture and methods of controlling the system.

### BACKGROUND

Carbon capture, utilization, and storage technologies can capture carbon dioxide at the source or directly from the air, enabling it to be reused for industrial or consumer applications. Current systems used to configure carbon capture systems rely on multiple localized controllers and sensors to manage numerous system components. Localized controllers are inefficient at performing the sophisticated computations required for a complex, multi-component active carbon capture system.

### SUMMARY OF THE DISCLOSURE

In an aspect, an active carbon capture system with a distributed control architecture includes at least a system component configured to receive a control signal and perform a carbon capture action as a function of the control signal; at least a first level control circuit communicatively connected to the at least one system component, the at least a first level control circuit configured to receive a command signal and transmit the control signal to the at least one system component as a function of the command signal; and at least a unit controller communicatively connected to the at least a first level control circuit, the at least a unit controller configured to detect at least a system parameter, generate the command signal as a function of the at least a system parameter, and transmit the command signal to the at least a first level control circuit.

In another aspect, a method of controlling an active carbon capture system with a distributed control architecture includes receiving, by at least a system component, a control signal; performing, by the at least a system component, a carbon capture action as a function of the control signal; receiving, by at least a first level control circuit communicatively connected to the at least one system component, a command signal; transmitting, by the at least a first level control circuit, the control signal to the at least one system component as a function of the command signal; detecting, by at least a unit controller communicatively connected to the at least a first level control circuit, at least a system parameter; generating, by the at least a unit controller, the command signal as a function of the at least a system parameter; and transmitting, by the at least a unit controller, the command signal to the at least a first level control circuit.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIGS. 1A-B are exemplary embodiments of block diagrams of an active carbon capture system with a distributed control architecture according to an embodiment of the invention;

FIG. 2 is an exemplary embodiment of an active carbon capture system;

FIG. 3 is an example embodiment of a partially sectional view of a carbon capture chamber;

FIG. 4 is a state diagram illustrating the operational states of a dual mode carbon capture chamber;

FIG. 5 is a flow diagram of an exemplary method 500 for controlling an active carbon capture system with a distributed control architecture; and

FIG. 6 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to an active carbon capture system with a distributed control architecture. In an aspect, conventional active carbon capture systems may be inefficient in achieving system-wide coordination and control due to tradeoffs between localized control, computing power, energy consumption, and the like. For instance, localized controllers, such as microcontrollers, often have limited processing speeds, smaller memory capacities, and restricted computational capabilities, which make it difficult to execute sophisticated control algorithms or context-aware decision-making across the system; on the other hand, central controllers can have unacceptable lag-times and can become overly complicated, prone to bugs, and single point of failure issues. To address these limitations, embodiments presented in the present disclosure provide an active carbon capture system with a distributed control architecture designed to improve the system's ability to achieve optimal efficiency, enhance carbon dioxide capture rates, and reduce energy consumption through intelligent, coordinated control. The active carbon capture system with a distributed control architecture is configured to include at least one system component that performs carbon capture functions. At least a first level control circuit is configured to directly control at least one system component. At least a unit controller is configured to send command signals to the first level control circuit, receive feedback from it, and adjust its own operational status accordingly. A master controller may be configured to directly control all unit controllers and issue system-wide control commands based on at least a system parameter. A remote device may be configured to communicate with the master controller to allow an end user to access system information, monitor performance metrics, and operate the system remotely.

In one or more embodiments, the distributed control architecture of system in this disclosure may provide significant advantages over both purely localized and purely centralized control approaches in the context of an active carbon capture system having numerous interdependent components and operational states. A purely localized control approach, in which individual microcontrollers independently manage valves, fans, vacuum pumps, temperature control systems, and sensors at each system component, may be limited in computational capacity, as localized controllers such as PIC-type microcontrollers may operate with lower processor speeds, reduced memory, and restricted instruction sets that may omit hardware multipliers and instead rely on addition and binary shift operations to approximate more complex arithmetic functions. These computational limitations may render purely localized control insufficient for executing sophisticated optimization algorithms, context-aware decision-making, or system-wide coordination across a plurality of carbon capture chambers operating asynchronously. Conversely, a purely centralized control approach, in which a single controller manages all system components directly, may introduce unacceptable communication latency, increased susceptibility to single-point-of-failure conditions, and excessive software complexity as the number of system components scales. To address these limitations, the system may employ a hierarchical, multi-tiered distributed control architecture in which at least a first level control circuit may be positioned at the lowest tier of the hierarchy and may be communicatively connected directly to at least a system component, including without limitation valve actuators, fans, vacuum pumps, temperature control systems, and sensors, thereby enabling low-latency, hardware-level control signal transmission to individual system components without requiring computational resources beyond those needed for discrete actuation and feedback acquisition. At least a unit controller, positioned at an intermediate tier, may be communicatively connected to one or more first level control circuits and may be configured to detect at least a system parameter, including without limitation carbon dioxide concentration, temperature, pressure, moisture level, airflow rate, and energy consumption, and to generate command signals as a function of the detected system parameters, thereby enabling context-aware, chamber-level decision-making that may account for the operational state of each associated system component without requiring global system awareness. A master controller, positioned at the highest local tier of the hierarchy, may be communicatively connected to a plurality of unit controllers and may be configured to track the operational states of all carbon capture chambers within the system, coordinate asynchronous chamber cycling to enable continuous airflow through at least a portion of the system while individual chambers undergo waste gas elimination, carbon dioxide collection, maintenance, repair, or replacement, and optimize system-wide energy consumption by selectively activating or deactivating chambers based on real-time economic and operational parameters. In one or more embodiments, the master controller may further be configured to communicate with a remote device, which may include a cloud server, mobile application, remote monitoring terminal, or centralized SCADA system, thereby enabling computationally intensive optimization processes, including without limitation machine learning algorithms and cross-site performance benchmarking, to be offloaded from local hardware to remote computing infrastructure, further reducing local computational load while enabling continuous improvement of system performance over time. In one or more embodiments, algorithms executed across the distributed control hierarchy may monitor and adjust variables including airflow rate, internal temperature, chamber pressure, and carbon dioxide concentration in parts per million, thereby optimizing carbon dioxide capture rates and energy usage in a coordinated manner that may not be achievable by localized controllers operating independently or by a single centralized controller managing all system components directly.

In one or more embodiments, the distributed control architecture of the system may provide significant advantages over both purely localized and purely centralized control approaches in the context of an active carbon capture system having numerous interdependent components and operational states. A purely localized control approach, in which individual microcontrollers independently manage valves, fans, vacuum pumps, temperature control systems, and sensors at each system component, may be limited in computational capacity, as localized controllers such as PIC-type microcontrollers may operate with lower processor speeds, reduced memory, and restricted instruction sets that may omit hardware multipliers and instead rely on addition and binary shift operations to approximate more complex arithmetic functions. These computational limitations may render purely localized control insufficient for executing sophisticated optimization algorithms, context-aware decision-making, or system-wide coordination across a plurality of carbon capture chambers operating asynchronously. Conversely, a purely centralized control approach, in which a single controller manages all system components directly, may introduce unacceptable communication latency, increased susceptibility to single-point-of-failure conditions, and excessive software complexity as the number of system components scales. To address these limitations, the system may employ a hierarchical, multi-tiered distributed control architecture in which at least a first level control circuit may be positioned at the lowest tier of the hierarchy and may be communicatively connected directly to at least a system component, including without limitation valve actuators, fans, vacuum pumps, temperature control systems, and sensors, thereby enabling low-latency, hardware-level control signal transmission to individual system components without requiring computational resources beyond those needed for discrete actuation and feedback acquisition. At least a unit controller, positioned at an intermediate tier, may be communicatively connected to one or more first level control circuits and may be configured to detect at least a system parameter, including without limitation carbon dioxide concentration, temperature, pressure, moisture level, airflow rate, and energy consumption, and to generate command signals as a function of the detected system parameters, thereby enabling context-aware, chamber-level decision-making that may account for the operational state of each associated system component without requiring global system awareness. A master controller, positioned at the highest local tier of the hierarchy, may be communicatively connected to a plurality of unit controllers and may be configured to track the operational states of all carbon capture chambers within the system, coordinate asynchronous chamber cycling to enable continuous airflow through at least a portion of the system while individual chambers undergo waste gas elimination, carbon dioxide collection, maintenance, repair, or replacement, and optimize system-wide energy consumption by selectively activating or deactivating chambers based on real-time economic and operational parameters. In one or more embodiments, the master controller may further be configured to communicate with a remote device, which may include a cloud server, mobile application, remote monitoring terminal, or centralized SCADA system, thereby enabling computationally intensive optimization processes, including without limitation machine learning algorithms and cross-site performance benchmarking, to be offloaded from local hardware to remote computing infrastructure, further reducing local computational load while enabling continuous improvement of system performance over time. In one or more embodiments, algorithms executed across the distributed control hierarchy may monitor and adjust variables including airflow rate, internal temperature, chamber pressure, and carbon dioxide concentration in parts per million, thereby optimizing carbon dioxide capture rates and energy usage in a coordinated manner that may not be achievable by localized controllers operating independently or by a single centralized controller managing all system components directly.

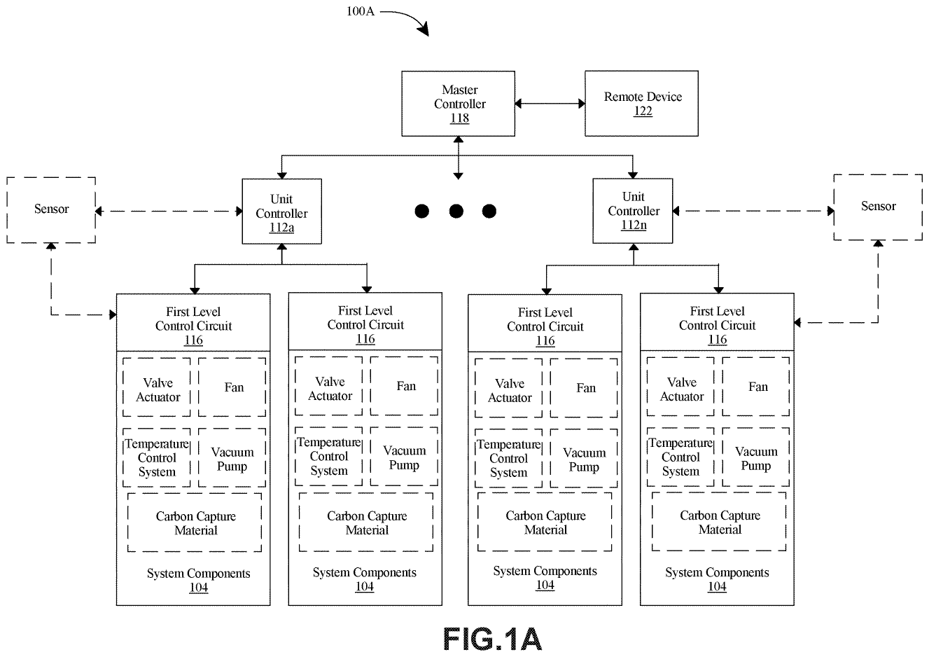

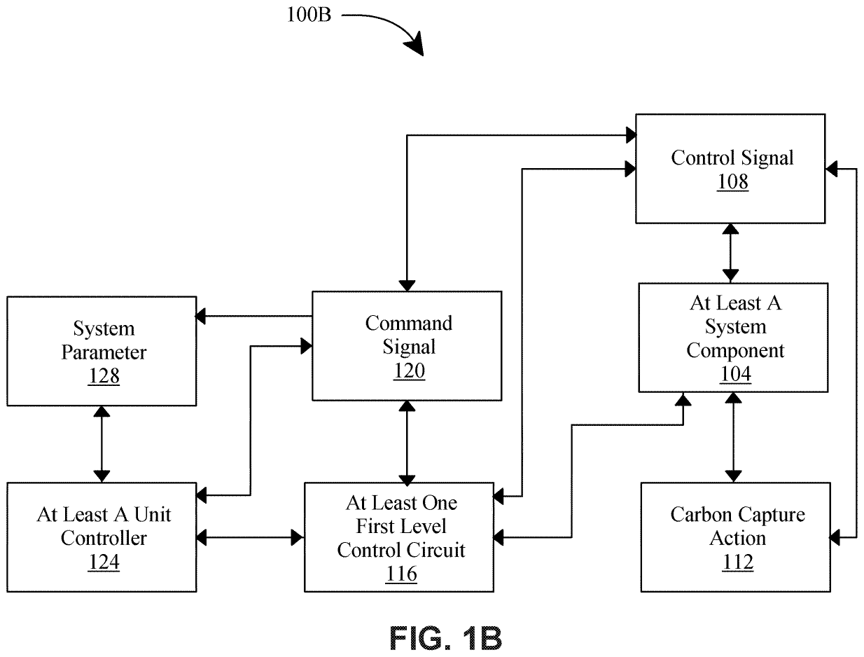

Referring now to FIGS. 1A-B, an exemplary embodiment of an active carbon capture system with a distributed control architecture 100 (hereinafter referred to as “system”) is illustrated. An “active carbon capture system with a distributed control architecture,” as used in this disclosure, refers to a carbon capture system that employs energy to actively drive carbon dioxide removal from air or other gas streams. In one or more embodiments, an active carbon capture system with a distributed control architecture may include system-wide monitoring, coordination, and control functions that are distributed across a hierarchy of interdependent controllers rather than being consolidated within a single centralized control unit or performed exclusively by localized, independent controllers. This distributed architecture may enable intelligent, coordinated decision-making across system components while mitigating computational limitations of purely localized control and single-point-of-failure risks associated with purely centralized control. An active carbon capture system may use external energy to capture carbon dioxide and remove carbon dioxide from the air. In one or more embodiments, a carbon capture system may include passive solutions, such as biochar, for carbon dioxide sequestration. Active carbon capture systems may actively flow air to an adsorbent material and actively remove carbon from the surrounding air. In one or more embodiments, an active carbon capture system may use fans and/or already existing infrastructure to divert flowing air to system 100a-b, wherein carbon dioxide may be actively removed from the surrounding air. In one or more embodiments, an active carbon capture system may rely on chemical adsorption and/or absorption or direct air capture using fans and sorbents. In one or more embodiments, an active carbon capture system may rely on external forces to direct air through the carbon capture system and forcibly remove carbon from the surrounding air. An active carbon capture system with a distributed control architecture 100 may be incorporated in and/or otherwise combined with a carbon capture system as disclosed in U.S. Nonprovisional application Ser. No. 19/204,954, filed on May 12, 2025, with attorney docket number 1706-001USU1 and entitled “CARBON CAPTURE SYSTEMS AND METHODS OF USE,” the entirety of which is incorporated herein by reference.

With continued reference to FIGS. 1A-B, system 100a-b is configured to include at least a system component 104. A “system component,” as used in this disclosure, is any subsystem within system that is configured to receive a control signal and perform a carbon capture action in furtherance of an active carbon capture process. In one or more embodiments, at least a system component 104 may include, without limitation, mechanical, electromechanical, thermal, fluidic, and sensing elements that collectively enable capture, sequestration, and collection of carbon dioxide. In one or more embodiments, at least a system component 104 may include, without limitation, valve actuators, fans, temperature control systems, vacuum pumps, carbon capture materials, and sensors, each of which is described in further detail below. In one or more embodiments, at least a system component 104 may include a valve actuator. A “valve actuator” for the purpose of this disclosure is a mechanical device that utilizes a power source to open and close a valve, thereby regulating fluid flow. In one or more embodiments, the power source may include, but is not limited to, electricity, compressed air, or hydraulic fluid. A “valve” for the purpose of this disclosure is a component that controls fluidic communication between two or more components. Exemplary non-limiting valves include directional valves, control valves, selector valves, multi-port valves, check valves, and the like. Valves may include any suitable valve construction, including ball valves, butterfly valves, needle valves, globe valves, gate valves, wafer valves, regulator valves, and the like. Valves may be included in a manifold of hydraulic or pneumatic circuits, for example, allowing for multiple ports and flow paths. Valves may be actuated by any known method, such as, without limitation, by way of hydraulic, pneumatic, mechanical, or electrical energy. For instance, in some cases, a valve may be actuated by an energized solenoid or electric motor. Valve actuators and thereby valves themselves may be controlled by a computing device and/or control circuit.

With continued reference to FIGS. 1A-B, at least a system component 104 may include a fan. A “fan” for the purpose of this disclosure is a mechanical device that draws in ambient air, circulates air through system components, and/or expels waste air or exhaust gases from the system. In one or more embodiments, a fan may include a motor-driven impeller or rotor configured to impart kinetic energy to a volume of air, thereby generating a pressure differential that drives airflow into, through, or out of system 100a-b. Exemplary non-limiting fan types include axial fans, centrifugal fans, mixed flow fans, and crossflow fans. In one or more embodiments, an axial fan may be configured to move air parallel to axis of rotation of fan's blades, making it suitable for high-volume, low-pressure airflow applications within system 100a-b. In one or more embodiments, a centrifugal fan may be configured to accelerate air radially outward from the center of rotation, thereby generating higher static pressures suitable for overcoming resistance within ductwork or system enclosures. In one or more embodiments, a mixed flow fan may combine axial and centrifugal flow characteristics, enabling intermediate pressure and flow rate performance. In one or more embodiments, a crossflow fan may be configured to draw air across full width of fan rotor, providing a substantially uniform airflow profile across a wide inlet, which may be advantageous for distributing air evenly across carbon capture material within system 100a-b. The fans may also be classified as forced draft fans, which push air into the system, and/or induced draft fans, which pull air or exhaust gases through the system. In one or more embodiments, a forced draft fan may be positioned upstream of system 100a-b or a carbon capture chamber to pressurize inlet and drive ambient air through the adsorbent and/or absorbent material. In one or more embodiments, an induced draft fan may be positioned downstream of carbon capture material to draw processed air or waste gas out of system 100a-b, thereby maintaining a negative pressure within the capture zone that promotes continued airflow through the adsorbent bed. Fan operation may be controlled by a computing device and/or control circuit. In one or more embodiments, fan operation may be modulated by varying the rotational speed of the fan motor using pulse-width modulation (PWM), variable frequency drive (VFD), or analog voltage control, enabling the system to adjust airflow rates in response to real-time sensor data such as carbon dioxide concentration, temperature, or pressure measurements. In one or more embodiments, one or more fans may be operated in parallel to increase aggregate airflow capacity or operated in series to achieve greater static pressure across the system. In one or more embodiments, fan speed and operational status may be monitored by at least a first level control circuit 116 through active component feedback sensors, such as back electromotive force (back-EMF) sensors or tachometer signals, which may provide real-time feedback on fan rotational speed and operational state to at least a unit controller 124 (112a to 112n in FIGS. 1A-BA) for closed-loop control of airflow within system 100a-b. A “first level control circuit,” as used in this disclosure, is a control element positioned at a lowest tier of a distributed control architecture of system. In one or more embodiments, at least a first level control circuit 116 may be configured to directly interface with and transmit control signals to at least a system component 104 in response to command signals received from at least a unit controller 124. In one or more embodiments, at least a first level control circuit 116 may include, without limitation, analog and/or digital circuitry, a microcontroller, a microprocessor, an application-specific integrated circuit (ASIC), a field-programmable gate array (FPGA), or any combination thereof. In one or more embodiments, at least a first level control circuit 116 may be configured to translate higher-level command signals from at least a unit controller 124 into discrete, hardware-level control signals suitable for direct actuation of system components such as fans, valve actuators, vacuum pumps, and temperature control systems. In one or more embodiments, at least a first level control circuit 116 may be configured to receive feedback from system components and transmit that feedback to at least a unit controller 124, thereby enabling closed-loop control of individual system components within the distributed control architecture. In one or more embodiments, a plurality of first level control circuits may be deployed across system 100a-b, each associated with a corresponding subset of system components, such that each first level control circuit 116 operates under the direction of at least a unit controller 124 while maintaining direct, low-latency communication with its associated system components.

With continued reference to FIGS. 1A-B, at least a system component 104 may include a temperature control system. In one or more embodiments, temperature control system may include a heat exchanger. A “heat exchanger” for the purpose of this disclosure is a system configured to transfer heat from between a heat source and/or sink and a fluid. For example, without limitation, a heat exchanger may include a device that transfers heat from a hot liquid, such as water, to air and carbon dioxide captured in system 100a-b. In one or more embodiments, a fluid may absorb heat from the heat exchanger and thereby cause the fluid to be heated. In one or more embodiments, a heat exchanger may include a solid barrier, wherein a heated fluid may transfer heat to a solid barrier, and a non-heated fluid may receive the heat from the solid barrier. In one or more embodiments, a heat exchanger may contact a surface of one or more carbon capture materials and/or at least a fin, wherein a heated fluid may contact a surface of one or more carbon capture materials and transfer heat to one or more carbon capture materials. In one or more embodiments, a heat exchanger may heat gas in system 100a-b by applying heat to one or more carbon capture materials. In one or more embodiments, in a heat exchanger, heat moves through a solid barrier, such as through or around tubular piping, wherein the heat exchanger may transfer heat onto one or more carbon capture materials. In one or more embodiments, air captured in system 100a-b may travel through an inner surface of one or more carbon capture materials, wherein a heat exchanger may contact an outer surface of one or more carbon capture materials and apply heat to one or more carbon capture materials. In one or more embodiments, a heat exchanger may include a heat pump configured to heat a fluid. In one or more embodiments, a heat pump may facilitate the movement of a heated fluid through piping and/or channels. In one or more embodiments, piping and/or channels may contact one or more carbon capture materials. In one or more embodiments, a heat exchanger may engage in a temperature swing adsorption (TSA) process wherein heat applied to one or more carbon capture materials may cause carbon dioxide to detach from the one or more carbon capture materials. In one or more embodiments, a heat exchanger may contact at least a fin within system 100a-b, and the heat exchanger may apply heat to at least a fin and thereby apply heat to system 100a-b. In one or more embodiments, heated fluid may be iteratively recirculated through a heat pump to apply additional heat to heated fluid, wherein heated fluid may transfer heat to system 100a-b. In one or more embodiments, heat exchanger may provide heat through a conduction process. In one or more embodiments, a conduction process is a process by which heat transfers through a solid material from a hotter region to a cooler region without the movement of the material itself. For example, and without limitation, a heat exchanger may transfer heat through one or more carbon capture materials and/or a material separating heat exchanger and one or more carbon capture materials. In one or more embodiments, a heated fluid may heat a thermally conductive material wherein the heat may be transferred to one or more carbon capture materials. In one or more embodiments, in a shell-and-tube or plate heat exchanger, hot and cold fluids may be separated by a solid metal barrier. In one or more embodiments, in thermal swing adsorption (TSA), heat exchange may warm up one or more carbon capture materials, for example, but not limited to zeolite, MOFs, and amines, to release captured carbon dioxide. Temperature control system may be controlled by a computing device and/or control circuit.

With continued reference to FIGS. 1A-B, system 100a-b may include one or more carbon capture materials. A “carbon capture material” for the purposes of this disclosure is a material that is capable of trapping molecules of a substance containing carbon or carbon dioxide. In one or more embodiments, carbon capture materials may capture, such as carbon dioxide. In one or more embodiments, one or more carbon capture materials may capture or trap molecules through a process called adsorption. “Adsorption” or the process of “adsorbing,” for the purpose of this disclosure, is a process in which molecules, ions, or atoms stick to a surface of another molecule through weak Van der Waals forces and/or chemical bonds. In one or more embodiments, during adsorption, molecules from a gas or liquid may encounter an adsorbent surface, such as one or more carbon capture materials. In one or more embodiments, molecules may adhere to the surface of a material without penetrating it. In one or more embodiments, adsorption may be contrasted with absorption, wherein absorption includes a process in which molecules penetrate the material. In one or more embodiments, one or more carbon capture materials may include materials capable of trapping and holding molecules on the surface of the adsorbent material. In one or more embodiments, one or more carbon capture materials may include, but are not limited to, Zeolites, activated carbon, Chitosan, Amine-functionalized sorbents, Silica gel, porous silicates, Metal-Organic Frameworks, amine-based sorbents, metal oxides, lithium silicates, Sodium zirconates, and/or the like. In one or more embodiments, one or more carbon capture materials may contain chemical properties that allow carbon dioxide to adhere to a surface of one or more carbon capture materials. In one or more embodiments, one or more carbon capture materials may contain chemical properties that allow for carbon dioxide to be separated from gas through a process of adsorption. In one or more embodiments, one or more carbon capture materials may contain amines that chemically bond with carbon dioxide. In one or more embodiments, one or more carbon capture materials may contain molecular-sized pores that trap carbon dioxide. In one or more embodiments, one or more carbon capture materials may adsorb carbon dioxide through physical adsorption. In one or more embodiments, physical adsorption or “physisorption” includes a process in which one or more carbon capture materials rely on high surface area and porous structures to trap carbon dioxide. In one or more embodiments, one or more carbon capture materials may contain a microporous structure that is used to capture carbon dioxide. In one or more embodiments, physisorption may contain weak van der Waals forces between carbon dioxide and one or more carbon capture materials in order to allow for the reuse of one or more carbon capture materials. In one or more embodiments, weak forces may allow for a system to trap carbon dioxide using one or more carbon capture materials and remove the carbon dioxide from the one or more carbon capture materials when desired. In one or more embodiments, one or more carbon capture materials may capture or trap molecules through a process called absorption. The purpose of this disclosure refers to a process in which carbon dioxide is removed from a gas mixture by dissolving into an absorbent material that selectively interacts with carbon dioxide. In one or more embodiments, one or more carbon capture materials may be a liquid solvent that has contact with gas in the system 100a-b. In one or more embodiments, one or more carbon capture materials may include, but are not limited to, physical solvents, amines (e.g., monoethanolamine, diethanolamine), potassium carbonate solutions, ionic liquids, nanofluid, and/or the like. In one or more embodiments, one or more carbon capture materials may contain chemical properties that allow for a chemical reaction between carbon dioxide and the solvent, such as acid-base or nucleophilic mechanisms. In one or more embodiments, one or more carbon capture materials may contain chemical properties that allow for carbon dioxide to be separated from gas through a process of absorption. In one or more embodiments, one or more carbon capture materials may contain physical properties that allow carbon dioxide to be bound by weak van der Waal forces in the solvent and allow for separation of carbon dioxide from air. In one or more embodiments, one or more carbon capture materials may operate under a principle consistent with Henry's law, which increases efficiency at partial pressure and low temperature.

With continued reference to FIGS. 1A-B, one or more carbon capture materials may include a material body with an adsorbent coating. In one or more embodiments, a material body may provide structure for one or more carbon capture materials. In one or more embodiments, a material body may be configured to withstand mechanical stresses, thermal cycling, and vacuum conditions encountered during repeated adsorption and desorption cycles within system 100a-b, such that structural integrity of carbon capture material is maintained over extended operational lifetimes. In one or more embodiments, a material body may include materials such as stainless steel, aluminum alloys, ceramic materials, such as silicon carbide and/or alumina, polymeric materials such as polyamides and polysulfides, and/or the like. In one or more embodiments, stainless steel may be selected for its corrosion resistance and high tensile strength, making it suitable for use in vacuum environments and high-temperature desorption cycles. In one or more embodiments, aluminum alloys may be selected for their favorable combination of low density, high thermal conductivity, and machinability, enabling efficient heat transfer between material body and the adsorbent coating during temperature swing adsorption (TSA) processes. In one or more embodiments, ceramic materials such as silicon carbide and/or alumina may be selected for their thermal stability at elevated desorption temperatures and their chemical inertness with respect to carbon dioxide, water vapor, and amine-based sorbents. In one or more embodiments, polymeric materials such as polyamides and polysulfides may be selected for applications requiring lower operating temperatures and where weight reduction or ease of fabrication is a design priority. In one or more embodiments, an adsorbent coating may provide adsorbent properties for one or more carbon capture materials. In one or more embodiments, an adsorbent coating may cover a surface of a material body. In one or more embodiments, an adsorbent coating may be applied to a surface of a material body through techniques including, but not limited to, dip-coating, spray-coating, chemical vapor deposition, or wash-coating, such that adsorbent coating forms a substantially uniform layer over the surface of material body to maximize available surface area for carbon dioxide adsorption. In one or more embodiments, thickness of adsorbent coating may be selected to balance adsorption capacity with mass transfer kinetics, wherein thinner coatings may allow for faster diffusion of carbon dioxide molecules to and from active adsorption sites, and thicker coatings may provide greater carbon dioxide capture capacity per unit area of material body surface. In one or more embodiments, an adsorbent coating may include zeolites, activated carbon, amines, and/or other materials as described above. In one or more embodiments, an adsorbent coating comprising zeolites may utilize a microporous crystalline aluminosilicate structure to physically adsorb carbon dioxide through size-selective molecular sieving and electrostatic interactions. In one or more embodiments, an adsorbent coating including activated carbon may utilize a high surface area, porous carbon structure to adsorb carbon dioxide through physisorption, wherein weak van der Waals forces between carbon dioxide molecules and activated carbon surface allow for reversible adsorption and desorption cycling. In one or more embodiments, an adsorbent coating comprising amines, such as amine-functionalized polymers including but not limited to Lewatit VP OC 1065, may chemically bond with carbon dioxide molecules through formation of carbamate or bicarbonate species, enabling selective capture of carbon dioxide from ambient air at low partial pressures. In one or more embodiments, adhesion between adsorbent coating and material body may be enhanced through surface treatment of material body prior to coating application, including but not limited to sandblasting, acid etching, or application of a primer or adhesive interlayer, thereby reducing delamination of the adsorbent coating during thermal cycling and vacuum operation within system 100a-b.

Still referring to FIGS. 1A-B, an element of one or more carbon capture materials may have a shape, such as, for example, a planar sheet, a cylindrical tube, and/or the like. In one or more embodiments, the shape of one or more carbon capture materials may include at least a fin. For the purposes of this disclosure, “a fin” is a flattened projection from a body. In one or more embodiments, a fin may act to maximize surface area for the purposes of adsorption, absorption, heat exchange, or the like. In one or more embodiments, at least a fin may include, but is not limited to, straight fins, annular fins, radial fins, and pin fins. In one or more embodiments, at least a fin may include copper and stainless steel, brazing techniques, and surface treatments that are employed to improve durability and thermal efficiency. In one or more embodiments, at least a fin may provide structural support within system 100a-b that can endure mechanical and thermal stresses under vacuum conditions.

In one or more embodiments, one or more carbon capture materials may be made of thermally conductive materials disposed within system 100a-b. In one or more embodiments, thermally conductive materials may be at least a fin. In one or more embodiments, thermally conductive material may contain physical properties capable of heat transfer. For example, and without limitation, thermally conductive material may include metals with high heat transfer coefficients in order to modify a temperature of one or more carbon capture materials. Thermally conductive material is said to have “thermally conductive properties” as described in this disclosure if it contains the ability to conduct heat. In one or more embodiments, at least a fin made of thermally conductive material may include a thermal conductivity of 10 (W/m·K) or greater. In one or more embodiments, thermal conductive properties may include aluminum, copper, stainless steel, silver, graphite, metals, and/or the like. In one or more embodiments, thermally conductive material is covered by one or more carbon capture materials configured to absorb carbon dioxide within a low temperature range. One or more carbon capture materials may be capable of capturing carbon dioxide at temperatures ranging from approximately 5 °C to 14 °C.

In one or more embodiments, one or more carbon capture materials may capture or trap molecules through a process called “electrochemical carbon capture.” “Electrochemical carbon capture,” for the purpose of this disclosure, is a process that uses electron transfer reaction to drive carbon dioxide separation from gas. In one or more embodiments, electrochemical carbon capture may include an electrochemical cell configured to generate acid/base pairs to control pH in solution, wherein at a relatively high pH, carbon dioxide may be captured as bicarbonate or carbonate, and at a relatively low pH, carbon dioxide may be released as a gas. In one or more embodiments, electrochemical carbon capture may include applying a voltage between two electrodes (anode and cathode) in an electrochemical cell that drives redox reactions, wherein the reaction may either consume or generate protons (H⁺) or hydroxide ions (OH⁻) which can modify the local pH of the system. In one or more embodiments, a basic environment in electrochemical carbon capture system may be used for carbon dioxide capture and an acidic environment may be used for carbon dioxide release. In one or more embodiments, voltage generated from the electrochemical carbon capture may adjust pH through electron flow. In one or more embodiments, adjusting pH in one or more carbon capture materials may include chemical adjustment by adding chemicals, like addition of acids and bases, to drive carbon dioxide capture. In one or more embodiments, electrochemical carbon capture may include electrochemically mediated amine regeneration, wherein amines may form carbamates with carbon dioxide in solution and a metal ion (e.g., Cu²⁺) may be electrochemically generated to displace carbon dioxide from the amine and allow regeneration without thermal input. In one or more embodiments, electrochemical carbon capture may include an electrochemical cell with an ion-exchange or bipolar membrane configured to separate acidic and basic regions, wherein carbon dioxide may be adsorbed and transported across the membrane via charged carbonate/bicarbonate species and may be released through local pH changes. In one or more embodiments, electrochemical carbon capture may include a faradaic electroswing adsorption process, wherein solid sorbents coated with redox-active functional groups may adsorb carbon dioxide under one electric potential and release it under another.

With continued reference to FIGS. 1A-B, at least a system component 104 may include a vacuum pump. A “vacuum pump” for the purpose of this disclosure refers to a mechanical device that is used to extract gases or other substances from system. In one or more embodiments, a vacuum pump may be configured to reduce the absolute pressure within system 100a-b below atmospheric pressure by mechanically displacing gas molecules from an enclosed volume, thereby creating a low-pressure environment suitable for facilitating desorption of carbon dioxide from one or more carbon capture materials and for removing waste gases from system 100a-b prior to carbon dioxide collection. In one or more embodiments, a vacuum pump may be configured to create and maintain a controlled vacuum environment suitable for operation of system 100a-b. In one or more embodiments, a controlled vacuum environment may be maintained within a pressure range of approximately 1 torr to 100 torr during waste gas elimination and carbon dioxide collection operations, wherein a specific target pressure may be determined by at least a unit controller 124 based on detected system parameter 128, including carbon dioxide concentration, temperature, and operational state of system 100a-b. In one or more embodiments, a vacuum pump may be configured to draw waste gas out of system 100a-b. In one or more embodiments, drawing waste gas out of system 100a-b may include extracting residual atmospheric gases such as nitrogen, oxygen, argon, and water vapor that remain within carbon capture chamber following carbon dioxide capture state, such that a purity of the carbon dioxide product stream collected during subsequent carbon dioxide collection state is maximized. In one or more embodiments, a vacuum pump may be used for carbon dioxide capture by reducing the pressure within system 100a-b. In one or more embodiments, reducing pressure within system 100a-b during carbon dioxide collection state may lower partial pressure of carbon dioxide within the carbon capture chamber, thereby shifting the adsorption equilibrium of the carbon capture material in favor of desorption and facilitating the release of captured carbon dioxide from the adsorbent and/or absorbent material without requiring additional thermal energy input beyond that provided by the temperature control system. Exemplary non-limiting vacuum pump types include dry screw pumps, claw pumps, and liquid ring pumps. In one or more embodiments, a dry screw pump may be configured to compress and transport gas through a pair of intermeshing helical screws without the use of sealing fluid, making it suitable for applications within system 100a-b where contamination of carbon dioxide product stream by pump fluid must be avoided. In one or more embodiments, a claw pump may be configured to utilize two claw-shaped rotors rotating in opposite directions within a pump housing to trap and displace gas volumes without contact between the rotors, providing an oil-free pumping mechanism suitable for maintaining the purity of extracted carbon dioxide. In one or more embodiments, a liquid ring pump may be configured to use a rotating impeller within a casing partially filled with a sealing liquid, such as water, to create a liquid ring that compresses and displaces gas, wherein sealing liquid simultaneously cools pump and condenses water vapor present in extracted gas stream, which may be advantageous during initial desorption stages when water vapor is a primary constituent being removed from system 100a-b. In one or more embodiments, system 100a-b may include a plurality of vacuum pumps configured to operate in a staged arrangement, wherein a first vacuum pump, such as a purge vacuum pump, may be configured to rapidly reduce pressure within carbon capture chamber from atmospheric pressure to an intermediate pressure level during waste gas elimination state, and a second vacuum pump, such as an extraction vacuum pump, may be configured to further reduce pressure and extract desorbed carbon dioxide product stream during carbon dioxide collection state, thereby preventing cross-contamination of carbon dioxide product with residual atmospheric gases. Vacuum pump operation may be controlled by a computing device and/or control circuit. In one or more embodiments, vacuum pump operation may be regulated by at least a first level control circuit 116 in response to command signals received from at least a unit controller 124, wherein command signals may instruct vacuum pump to activate, deactivate, or adjust operational parameters such as pumping speed or target pressure setpoint based on detected system parameter 128 including internal chamber pressure, carbon dioxide concentration, and the current operational state of system 100a-b. In one or more embodiments, a pressure sensor communicatively connected to at least a first level control circuit 116 may provide real-time pressure measurements within system 100a-b, enabling closed-loop pressure control by at least a unit controller 124 to maintain target vacuum levels throughout the waste gas elimination state and carbon dioxide collection state.

With continued reference to FIGS. 1A-B, at least a system component 104 may include a plurality of sensors. In one or more embodiments, the sensors may be configured to measure carbon dioxide concentrations within the system 100a-b during operation. In one or more embodiments, a plurality of sensors may include a nondispersive infrared sensor capable of detecting the presence and concentrations of carbon dioxide. In one or more embodiments, a plurality of sensors may be in communication with at least a first level control circuit 116 and configured to transmit real-time measurement data. At least a first level control circuit 116 may analyze sensor input to determine the appropriate operational state of the system, as described in further detail below. For example, and without limitation, when carbon dioxide concentrations reach a predefined threshold, at least a first level control circuit 116 may transmit one or more command signals to activate or adjust the system. In one or more embodiments, at least a first level control circuit 116 may transmit signals to the temperature control system to initiate heating or cooling cycles for carbon capture processes. In one or more embodiments, at least a first level control circuit 116 may transmit signals to the carbon dioxide collection system to begin collecting released carbon dioxide.

With continued reference to FIGS. 1A-B, a plurality of sensors may include at least a moisture sensor. “Moisture,” as used in this disclosure, is a presence of water. In one or more embodiments, moisture may include vaporized water in air, condensation on the surfaces of objects, or concentrations of liquid water. Moisture may include humidity. “Humidity,” as used in this disclosure, is the property of a gaseous medium (almost always air) to hold water in the form of vapor. In an embodiment, a moisture sensor may include a hygrometer. An amount of water vapor contained within a parcel of air can vary significantly. Water vapor is generally invisible to the human eye and may be damaging to electrical components. There are three primary measurements of humidity: absolute, relative, and specific humidity. “Absolute humidity,” for the purpose of this disclosure, describes the water content of air and is expressed in either grams per cubic meter or grams per kilogram. “Relative humidity,” for the purpose of this disclosure, is expressed as a percentage, indicating a present stat of absolute humidity relative to maximum humidity given the same temperature. “Specific humidity,” for the purpose of this disclosure, is the ratio of water vapor mass to total moist air parcel mass, where the parcel is a given portion of a gaseous medium. Humidity sensor may be a psychrometer. Humidity sensor may be a hydrometer. Humidity sensor may be configured to act as or include a humidistat. A “humidistat,” for the purpose of this disclosure, is a humidity-triggered switch, often used to control another electronic device. Humidity sensor may use capacitance to measure relative humidity and include it in itself, or as an external component, include a device to convert relative humidity measurement to absolute humidity measurements. In one or more embodiments, system 100a-b may include at least a moisture sensor configured to measure moisture datum of carbon dioxide capture. A “moisture datum” for the purpose of this disclosure is information associated with the moisture within a system 100a-b. In one or more embodiments, moisture datum may be used to identify the presence of water molecules within the system 100a-b during adsorption and/or absorption of carbon dioxide. In one or more embodiments, during adsorption and/or absorption, water molecules may attach and/or adsorb/absorb to carbon capture material and/or other portions of system 100a-b. In one or more embodiments, at least moisture sensor may be configured to sense and/or generate moisture datum by identifying the amount of moisture within the system 100a-b.

With continued reference to FIGS. 1A-B, a plurality of sensors may include a nondispersive infrared sensor configured to measure a concentration of carbon dioxide in system 100a-b. A “nondispersive infrared sensor,” for the purposes of this disclosure, is a sensor that measures the concentration of gas using infrared absorption. Nondispersive infrared sensor may contain an infrared light source that emits a broad spectrum of infrared light. Differing gases, within the system 100a-b, absorb the infrared light at specific wavelengths. For example, and without limitation, carbon dioxide may absorb infrared radiation at around 4.26 micrometers. In one or more embodiments, nondispersive infrared sensors may use optical filters to only allow infrared light at wavelengths associated with the gas to be measured (e.g., carbon dioxide at 4.26 microns). In one or more embodiments, Infrared detector may measure how much infrared light passes through the sample, wherein less transmitted light may indicate a higher carbon dioxide concentration.

With continued reference to FIGS. 1A-B, a plurality of sensors may include a pressure sensor. A “pressure,” for the purposes of this disclosure, and as would be appreciated by someone of ordinary skill in the art, is a measure of force required to stop a fluid from expanding and is usually stated in terms of force per unit area. In non-limiting exemplary embodiments, a pressure sensor may be configured to measure an atmospheric pressure and/or a change of atmospheric pressure. In some embodiments, a pressure sensor may include an absolute pressure sensor, a gauge pressure sensor, a vacuum pressure sensor, a differential pressure sensor, a sealed pressure sensor, and/or other unknown pressure sensors, alone or in a combination thereof. A pressure sensor may include a barometer. In some embodiments, a pressure sensor may be used to indirectly measure fluid flow, speed, water level, and altitude. In some embodiments, a pressure sensor may be configured to transform pressure into an analogue electrical signal. In some embodiments, pressure sensor may be configured to transform pressure into a digital signal.

With continued reference to FIGS. 1A-B, a plurality of sensors may include at least an anemometer that is used to measure air speed. An “anemometer,” for the purpose of this disclosure, is a sensor that measures airflow velocity. In one or more embodiments, system 100a-b may include at least an anemometer that is configured to monitor airflow dynamics during various operational states. In one or more embodiments, at least an anemometer may be positioned adjacent to intake valve and outlet valve to detect airflow when the valves are either open or closed. For example, without limitation, at least an anemometer in system 100a-b may include a hot-wire anemometer, a vane anemometer, a pitot tube anemometer, or an ultrasonic anemometer. In one or more embodiments, at least an anemometer may include, but are not limited to, a hot-wire anemometer that may operate by measuring the rate of heat loss from a heated wire exposed to the airflow. In some embodiments, at least an anemometer may be a vane anemometer that is configured to measure airflow by a rotating vane whose rotational speed correlates with airflow velocity. In some embodiments, at least an anemometer may be a pitot tube anemometer that is configured to measure the difference between the stagnation pressure and the static pressure of the airflow, such pressure difference can be used to calculate airflow rates. In some embodiments, at least an anemometer may be an ultrasonic anemometer that is configured to emit ultrasonic pulses between transducers and measure the transit time of these pulses. The presence of airflow may affect the transit time, allowing for a non-intrusive measurement of air speed without any moving parts. In some embodiments, at least an anemometer sensor may be configured to transform air speed into an analogue electrical signal. In some embodiments, at least an anemometer sensor may be configured to transform air speed into a digital signal.

With continued reference to FIGS. 1A-B, a plurality of sensors may include at least a temperature sensor. A “temperature sensor,” for the purpose of this disclosure, is a sensor that detects and measures temperature. In one or more embodiments, system 100a-b may include at least a temperature sensor that is configured to measure temperature during various operational states. For example, without limitation, at least a temperature sensor in system 100a-b may include resistance temperature detectors (RTDs), thermocouples, thermistors, and infrared (IR) sensors. In one or more embodiments, at least a temperature sensor may include, but is not limited to, resistance temperature detectors (RTDs) that may operate based on the linear relationship between temperature and electric resistance of a metal wire. In one or more embodiments, at least a temperature sensor may include a thermocouple that is configured with two dissimilar metal wires joined at a sensing junction. This junction may experience a temperature gradient and generate a voltage proportional to the temperature difference between the junction and the reference end, thereby enabling temperature measurement. In some embodiments, at least a temperature sensor may include at least a thermistor that is configured to have temperature-sensitive resistors that exhibit a significant resistance change with temperature variation, thereby enabling temperature measurement. In some embodiments, at least a temperature sensor may include infrared sensors that are configured to detect temperature by measuring the infrared radiation emitted by components or surfaces. In some embodiments, at least a temperature sensor may be configured to transform temperature into an analogue electrical signal. In some embodiments, at least a temperature sensor may be configured to transform temperature into a digital signal.

With continued reference to FIGS. 1A-B, a plurality of sensors may include at least an active component feedback sensor. An “active component feedback sensor,” for the purpose of this disclosure, is a sensor that collects feedback directly from active components based on electrical, mechanical, or operational characteristics. In one or more embodiments, system 100a-b may include at least an active component feedback sensor that is configured to gather operational feedback from active system components, such as, without limitation, fans, a temperature control system, and at least a vacuum pump. For example, without limitation, at least an active component feedback sensor may include back electromotive force (back EMF) sensors, power consumption monitors, and vibration sensors. In one or more embodiments, back EMF sensors may be configured to estimate motor speed based on the voltage generated by the rotation of the fan motor. In one or more embodiments, power consumption monitors may be used to infer different component energy efficiency or to detect abnormal conditions. In one or more embodiments, vibration sensors may be used to detect deviations in mechanical operation, thus indicating potential faults or maintenance needs. In some embodiments, at least an active component feedback sensor may be configured to transform at least one operational parameter into an analogue electrical signal. In some embodiments, at least an active component feedback sensor may be configured to transform at least one operational parameter into a digital signal.

With continued reference to FIGS. 1A-B, a plurality of sensors may include at least an electrical parameter sensor. An “electrical parameter sensor,” for the purpose of this disclosure, is a sensor that detects and measures electrical properties. In one or more embodiments, at least an electrical parameter sensor may be configured to monitor electrical characteristics of system 100a-b. At least an electrical parameter sensor may include, but not be limited to, voltage sensors, current sensors, resistance sensors, capacitance sensors, and inductance sensors.

In one or more embodiments, voltage sensors may detect voltage levels within system 100a-b by using principles such as resistive dividers, capacitive coupling, or electromagnetic induction to create a signal proportional to the measured voltage. In one or more embodiments, voltage sensors may include, but are not limited to, resistive voltage sensors, capacitive voltage sensors, and inductive voltage sensors. In one or more embodiments, current sensors may detect current within system 100a-b by measuring the electrical current flowing through a conductor and convert it into a measurable output signal. In one or more embodiments, voltage sensors may monitor supply voltages to fans, at least a vacuum pump, a temperature control system, at least a first level control circuit 116, at least a unit controller 124, and a master controller 118.

In one or more embodiments, current sensors may include, but are not limited to, Hall effect sensors, inductive sensors, shunt resistor sensors, fluxgate sensors, optical sensors. In one or more embodiments, current sensors may detect current draw variations to infer the load and operational status of fans, pumps, or heating elements.

In one or more embodiments, resistance sensors may measure changes in electrical resistance to determine conditions, including but not limited to, temperature, light, and force. In one or more embodiments, resistance sensors may include, but are not limited to, resistance temperature detectors, thermistors, photoresistors, force-sensing resistors, and conductive level sensors. In one or more embodiments, resistance sensors may monitor temperature variations, detect pressure changes, and measure mechanical stress within system 100a-b.

In one or more embodiments, capacitance sensors may detect the presence of an object by sensing changes in capacitance. In one or more embodiments, capacitance sensors may include but are not limited to, capacitive proximity sensors and capacitive level sensors. In one or more embodiments, capacitance sensors may monitor moisture levels, detecting presence of liquids or solids within system 100a-b. In one or more embodiments, inductance sensors may detect objects by measuring changes in the inductance of a coil when an object made of conductive materials approaches. In one or more embodiments, inductance sensors may monitor the positions of valves, detect the presence of metal components, and ensure proper alignment of mechanical parts.

With continued reference to FIGS. 1A-B, at least a system component 104 is configured to receive a control signal 108. A “control signal,” for the purpose of this disclosure, refers to a command or instruction used to regulate and/or optimize various system processes. For example, and without limitation, control signal 108 may include carbon dioxide capturing, temperature adjustment, vacuum pressure control, and airflow speed adjustment. In one or more embodiments, control signal 108 may be configured to regulate the airflow speed within system 100a-b by controlling fans' operation. In one or more embodiments, control signal 108 may command the fan to initiate rotation to achieve a desired airflow speed based on measured carbon dioxide concentration within system 100a-b. In one or more embodiments, a control signal 108 may command the fan to stop rotation, thereby preventing air from entering or exiting system 100a-b. In one or more embodiments, control signal 108 may be configured to regulate the valve actuator of system 100a-b by commanding valves to open or close, depending on different stages of system operation. In one or more embodiments, control signal 108 may be configured to regulate the temperature control system of system 100a-b. In one or more embodiments, control signal 108 may command the temperature control system to adjust the temperature of system 100a-b. In one or more embodiments, a control signal 108 may regulate vacuum pressure within system 100a-b by controlling the operation of one or more vacuum pumps. In one or more embodiments, control signal 108 may command a vacuum pump to operate in different modes or adjust the intensity of the vacuum pressure, depending upon system requirements.

With continued reference to FIGS. 1A-B, at least a system component 104 is configured to perform a carbon capture action 112 based on control signal 108. A “carbon capture action,” as used in this disclosure, is any state change performed by at least a system component in response to a control signal. In one or more embodiments, an operation, adjustment, or state change may be directed toward facilitating, optimizing, or advancing one or more stages of carbon dioxide capture process, including without limitation the intake of ambient air, the adsorption and/or absorption of carbon dioxide onto carbon capture material, an elimination of waste gases, the desorption and collection of captured carbon dioxide, and thermal and pressure management operations that support each of these stages. In one or more embodiments, carbon capture action 112 may be a discrete binary operation, such as turning a component on or off, or may be a graduated adjustment, such as modifying fan speed, temperature setpoint, or vacuum pressure level. In one or more embodiments, carbon capture action 112 may be performed by a single system component or may be performed concurrently and/or sequentially across a plurality of system components in a coordinated manner to advance system 100a-b through its operational states. In one or more embodiments, carbon capture action 112 may include turning on the fan when the carbon dioxide concentration within system 100a-b is low, and additional air may be required to refill system 100a-b. In one or more embodiments, carbon capture action 112 may include turning on the fan when system 100a-b may need to expel waste air before initiating a carbon collection cycle. In one or more embodiments, carbon capture action 112 may include turning off the fan when the carbon dioxide concentration within system 100a-b reaches a required threshold, the system is ready for the carbon capture cycle, and system 100a-b may be sealed. In one or more embodiments, carbon capture action 112 may include adjusting the fan speed to control the amount of airflow entering or exiting the system 100a-b, depending upon carbon dioxide capture requirements. In one or more embodiments, carbon capture action 112 may include increasing the fan speed when system 100a-b may require a greater volume of air to enhance carbon dioxide collection. In one or more embodiments, carbon capture action 112 may include increasing fan speed when system 100a-b may need to remove waste gas. In one or more embodiments, a carbon capture action 112 may include decreasing the fan speed when system 100a-b may need to conserve energy while either filling system 100a-b with air and/or expelling waste gas. In one or more embodiments, a carbon capture action 112 may include opening a valve when the carbon dioxide concentration within system 100a-b is low, and additional air may be required to refill system 100a-b. In one or more embodiments, carbon capture action 112 may include closing a valve when the carbon dioxide concentration within system 100a-b reaches a required threshold, the system is ready for the carbon dioxide capture cycle, and system 100a-b may be sealed. In one or more embodiments, carbon capture action 112 may include pumping hot water through a heat exchanger, thereby increasing the internal temperature of system 100a-b when the moisture level of system 100a-b may reach a certain threshold. In one or more embodiments, carbon capture action 112 may include pumping cold water through the heat exchanger, thereby decreasing the internal temperature of system 100a-b when the system 100a-b enters the carbon dioxide capture cycle. In one or more embodiments, carbon capture action 112 may include turning on the vacuum pumps when the system 100a-b is expelling waste gas. In one or more embodiments, carbon capture action 112 may include turning on the vacuum pump when the system 100a-b is collecting carbon dioxide. In one or more embodiments, carbon capture action 112 may include turning off the vacuum pump when the system 100a-b is collecting air to refill the system. In one or more embodiments, multiple carbon capture actions may be signaled by control signal 108 simultaneously or independently.

With continued reference to FIGS. 1A-B, system 100a-b is configured to include at least a first level control circuit 116, which can also be referred to as a “first level controller” or “first level sub-controller” herein. Control circuit may include any analog and/or digital components configured or assembled to perform functions as described below. Control circuit may include, without limitation, an operational amplifier circuit, a combinational logic circuit, and/or a sequential logic circuit. Control circuit may include circuitry such as, without limitation, a processor communicatively connected to a memory; for instance, circuitry may include and/or be included in a computing device. As used in this disclosure, “communicatively connected” means connected by way of a connection, attachment, or linkage between two or more relata, such as, without limitation, electronic components, modules, and/or devices, which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example, and without limitation, through wired or wireless electronic, digital, or analog communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example, and without limitation, wireless connection, radio communication, low power wide area network, optical communication, magnetic, capacitive, or optical coupling, and the like. In some instances, the terminology “communicatively coupled” may be used in place of “communicatively connected” in this disclosure.

With continued reference to FIGS. 1A-B, memory may include a primary memory and a secondary memory. “Primary memory,” also known as “random access memory” (RAM) for the purposes of this disclosure, is a short-term storage device in which information is processed. In one or more embodiments, during use of the computing device, instructions and/or information may be transmitted to primary memory, wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “volatile memory,” wherein the volatile memory only holds information while data is being used and/or processed. In one or more embodiments, volatile memory may lose information after a loss of power. “Secondary memory,” also known as “storage,” “hard disk drive,” and the like, for the purposes of this disclosure, is a long-term storage device in which an operating system and other information is stored. In one or more embodiments, information may be retrieved from secondary memory and transmitted to primary memory during use. In one or more embodiments, secondary memory may be referred to as non-volatile memory, wherein information is preserved even during a loss of power. In one or more embodiments, data within secondary memory cannot be accessed by a processor. In one or more embodiments, data is transferred from secondary to primary memory, wherein circuitry may access the information from primary memory.

Control circuit may alternatively or additionally be implemented by configuring a hardware device, such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as, without limitation, in a system-on-chip architecture wherein some functions are configured by modification or design of hardware circuitry, such as, without limitation, FPGA circuitry, while others are configured in the form of instructions in memory for one or more processors. As a non-limiting example, any step or combination of steps described herein may be performed entirely using hardware circuit configured to perform such steps, either with static memory or rewritable memory. Such steps or combinations of steps may include signing with a digital signature, cryptographically hashing, evaluation of zero-knowledge proofs, or any other specific process described in this disclosure.

Further referring to FIGS. 1A-B, control circuit may include any computing device as described in this disclosure, including, without limitation, a microcontroller, microprocessor, digital signal processor (DSP), and/or system on a chip (SoC) as described in this disclosure. Control circuit may include, be included in, and/or communicate with a mobile device, such as a mobile telephone or smartphone. Control circuit may include a single computing device operating independently or may include two or more computing devices operating in concert, in parallel, sequentially, or the like; two or more computing devices may be included together in a single computing device or in two or more computing devices. Control circuit may interface or communicate with one or more additional devices as described below in further detail via a network interface device. Network interface device may be utilized for connecting control circuit to one or more of a variety of networks and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from a computer and/or a computing device. Control circuit may include, but are not limited to, for example, a computing device or cluster of computing devices in a first location and a second computing device or cluster of computing devices in a second location. Control circuit may include one or more computing devices dedicated to data storage, security, distribution of traffic for load balancing, and the like. Control circuit may distribute one or more computing tasks, as described below, across a plurality of computing devices of a computing device, which may operate in parallel, in series, redundantly, or in any other manner used for distribution of tasks or memory between computing devices. Control circuit may be implemented, as a non-limiting example, using a “shared nothing” architecture.

With continued reference to FIGS. 1A-B, control circuit may be designed and/or configured to perform any method, method step, or sequence of method steps in any embodiment described in this disclosure, in any order, and with any degree of repetition. For instance, control circuit may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Control circuit may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIGS. 1A-B, system 100a-b may include at least a microcontroller. A “microcontroller,” for the purpose of this disclosure, is a small computer on a single integrated circuit that is designed to control specific functions in embedded systems. In one or more embodiments, microcontrollers may include a processor core, memory units (RAM, ROM, or flash), and input/output interfaces. For example, without limitation, at least a microcontroller may include general-purpose microcontrollers, low-power microcontrollers, and microcontrollers integrated into specialized packages. In one or more embodiments, general-purpose microcontrollers may be used in embedded control applications. In one or more embodiments, low-power microcontrollers may be designed for energy-efficient systems. In one or more embodiments, a microcontroller may be part of an integrated solution that combines motor driver circuitry, control logic, and sensing capabilities into a single device, such as an embedded motor controller module or a system-on-chip (SoC) for actuator control. In one or more embodiments, at least a microcontroller may be configured to, but not limited to, regulate fan speed, actuate valves, control vacuum pump operation, manage heating and cooling through a temperature control system, and acquire sensor signals.

In one or more embodiments, at least a first level control circuit 116 is configured to receive a command signal 120. A “command signal,” as used in this disclosure, is a directive or instruction sent by a controller to influence or regulate the operation of a system. Command signal 120 may include one or more instructions for performing carbon capture action 112. A command signal 120 may be based on environmental parameters or system parameters 128 received and processed by at least a unit controller 124. In one or more embodiments, command signal 120 may include digital or analog data. In one or more embodiments, command signal 120 may include a fan activation instruction (e.g., on/off and/or various speed level settings). In one or more embodiments, command signal 120 may include a valve control command (e.g., open/close state). In one or more embodiments, command signal 120 may include a temperature adjustment request (e.g., activating heating or cooling subsystems). In one or more embodiments, command signal 120 may include a vacuum pump control directive (e.g., enable/disable and/or change of operational mode). In one or more embodiments, command signal 120 may include a single signal or a combination of multiple signals. In one or more embodiments, at least a first level control circuit 116 may receive command signal 120 and transmit a corresponding control signal 108 to at least a system component 104. In one or more embodiments, command signal 120 may represent a simple binary state, such as an on/off instruction. In one or more embodiments, a command signal 120 may include a more complex data packet or string containing multiple parameters, such as but not limited to, power levels, operational states, or positional information. In one or more embodiments, command signal 120 may be encoded using binary encoding schemes and formatted as structured data packets suitable for interpretation by at least a first level control circuit 116. In one or more embodiments, command signal 120 may be transmitted to at least a first level control circuit 116 via any suitable communication method, including, without limitation, wired electronic connections, serial data protocols (e.g., I2C, SPI, UART), or wireless communication techniques.

With continued reference to FIGS. 1A-B, system 100a-b is configured to include at least a unit controller 124. A “unit controller,” as used in this disclosure, is a control system that either manages the operation of a carbon capture unit or an entire active carbon capture system. In one or more embodiments, at least a unit controller 124 may include any kind of controller that is suitable to perform the function of a first level control circuit 116. In one or more embodiments, at least a unit controller 124 may control at least one carbon capture chamber. In one or more embodiments, at least a unit controller 124 may control the entire active carbon capture system. In one or more embodiments, at least a unit controller 124 may operate under a plurality of states. In one or more embodiments, at least a unit controller 124 may be in communication with at least a first level control circuit 116. In one or more embodiments, at least a unit controller 124 may be configured to have current situation of at least a system component 104. In one or more embodiments, the at least a unit controller 124 may be configured to operate under a plurality of states, wherein a change between a plurality of states may be triggered by detection of at least a system parameter 128, and wherein a plurality of states may include a carbon dioxide capture state, a waste gas elimination state, and a carbon dioxide collection state.

With continued reference to FIGS. 1A-B, at least a unit controller 124 is configured to detect at least a system parameter 128. A “system parameter,” as used in this disclosure, is a variable that influences the performance, efficiency, operation, or cost associated with an active carbon capture system. For example, without limitation, at least a system parameter 128 may include environmental parameters such as carbon dioxide concentration, moisture level, temperature, pressure, air flow rate, and water flow rate. At least a system parameter 128 may include economic parameters such as carbon capture material degradation rate, carbon dioxide capture rate, and energy usage. At least a system parameter 128 may include operation parameters such as a measure of elapsed time, cycle duration, and system uptime. At least a system parameter 128 may include command instructions received from a master controller.

With continued reference to FIGS. 1A-B, at least a controller is configured to operate under a plurality of states. In one or more embodiments, at least a controller operates in at least one of the states, which operates in at least one of the following states: a carbon capture state, a waste gas elimination state, or a carbon collection state. In one or more embodiments, carbon capture state may be associated with actions including, without limitation, opening intake and outlet valves and activating airflow into the system until the chamber is filled with air at a predefined carbon dioxide concentration. Carbon capture state may also include detecting moisture levels within the system prior to initiating waste gas elimination state or carbon collection state. Moisture levels may exceed predefined criteria; as a result, the carbon capture state may be associated with actions including, without limitation, activating the temperature control system to increase the internal temperature of the system, thereby reducing the moisture content. Carbon capture state may include subsequent actions including decreasing the internal temperature of the system to allow for carbon dioxide to adsorb and/or absorb into the carbon capture material. In one or more embodiments, a waste gas elimination state may be associated with actions including operating a vacuum pump to pressurize the system, thereby drawing out the waste gas (e.g., gases that do not contain carbon dioxide or have insufficient carbon dioxide concentrations) through a waste gas outlet prior to initiating the carbon collection state. In one or more embodiments, a carbon collection state may be associated with actions including raising the internal temperature of the system to facilitate the release of carbon dioxide from the carbon capture material. A carbon collection state may be associated with actions including operating a vacuum pump to pressurize the system and draw the released carbon dioxide into a carbon dioxide collection system for storage, utilization, or further processing.

With continued reference to FIGS. 1A-B, at least a unit controller 124 changes or transitions between the plurality of states as a result of the detection of at least a system parameter 128. In one or more embodiments, at least a system parameter 128 may be at least an environmental parameter. In one or more embodiments, at least a unit controller 124 may detect the carbon dioxide concentration within the system, and if the carbon dioxide concentration is lower than a predefined threshold, may switch the system into the carbon capture state. In one or more embodiments, at least a unit controller 124 may detect the moisture level within the system and, if the detected moisture level exceeds a predefined moisture threshold, may increase the internal temperature of the system accordingly. In one or more embodiments, at least a unit controller 124 may detect the internal temperature of the system and adjust the temperature according to predefined setpoints corresponding to moisture removal, carbon capture state, or carbon collection state. In one or more embodiments, at least a controller may detect the system pressure and adjust the pressure to predefined set points suitable for waste gas elimination and carbon collection states. In one or more embodiments, at least a controller may detect the air flow within the system and increase the air flow rate if additional air is required to fill the chamber during the carbon capture state or may stop the airflow when the system is either in a waste gas elimination state or a carbon collection state. In one or more embodiments, at least a controller may detect the water flow rate of the temperature control system and adjust the water flow by circulating cold water during the carbon capture state to facilitate carbon dioxide adsorption and/or absorption. In one or more embodiments, at least a unit controller 124 may adjust the water flow rate to circulate hot water during the carbon collection state to facilitate the release of carbon dioxide from the carbon capture material.

In one or more embodiments, at least a system parameter 128 may be at least an operational parameter. In one or more embodiments, at least a controller may detect cycle duration and carbon dioxide concentration within the carbon capture system and adjust the cycle duration accordingly to optimize carbon dioxide capture efficiency. In one or more embodiments, at least a controller may determine whether system components are operating correctly by monitoring the operational status and working conditions of each component. If certain components or chambers may be detected as malfunctioning or offline, at least a controller may adjust system operation by selectively alternating chambers and redistributing workloads among functional chambers. In one or more embodiments, at least a controller may detect operation parameters to determine overall system uptime. In one or more embodiments, at least a controller may measure elapsed operational time to evaluate the efficiency and effectiveness of carbon dioxide capture.

In one or more embodiments, at least a system parameter 128 may be at least an economic parameter. In one or more embodiments, at least a unit controller 124 may utilize environmental parameters to calculate and optimize carbon dioxide capture rate, including but not limited to monitoring vacuum pump operating times and quantifying the amount of carbon dioxide collected in the carbon dioxide collection system. In one or more embodiments, this optimization may include strategically activating a subset of available carbon capture chambers rather than simultaneously running all chambers, thereby maximizing overall efficiency, and reducing unnecessary energy usage. In one or more embodiments, at least a unit controller 124 may determine the degradation rate of the carbon capture material based on the cumulative amount of carbon dioxide captured over time. This determination may inform system-wide decisions, for example, but not limited to prompting a user to replace degraded carbon dioxide capture materials or adjusting vacuum pump operation parameters to maintain efficient carbon dioxide collection. In one or more embodiments, at least a unit controller 124 may detect the total energy consumption of the carbon capture system and optimize energy usage by selectively operating certain carbon capture chambers. For example, at least a unit controller 124 may deactivate or limit operations of chambers that are associated with higher energy cost or reduce the operation of chambers whose carbon capture material has significantly degraded, thereby ensuring cost-effective and energy efficient operation.

With continued reference to FIGS. 1A-B, at least a unit controller 124 is configured to generate command signal 120 based on at least an environmental parameter and to transmit the command signal 120 to the at least a first level control circuit 116. In one or more embodiments, if the carbon dioxide concentration within the system may be detected to be low, at least a unit controller 124 may generate a command signal 120 to open the valve and activate the fan to draw air into the chamber. Command signal 120 may be transmitted to at least a first level control circuit 116 to initiate preparation for a subsequent carbon capture cycle. In one or more embodiments, if the carbon dioxide concentration within the system may be detected to have reached a predefined threshold suitable for a carbon capture cycle, at least a unit controller 124 may generate a command signal 120 to close the valve, deactivate the fan, activate cooling subsystems, and subsequently activate the vacuum pump. Command signal 120 may be transmitted to at least a first level control circuit 116 to lower the internal temperature, thereby facilitating carbon dioxide adsorption or absorption by the carbon dioxide capture material. In one or more embodiments, if the moisture level within the system may exceed a predefined threshold, at least a unit controller 124 may generate command signal 120 to activate heating subsystem. This command signal 120 may be transmitted to at least a first level control circuit 116 to increase the internal temperature, thereby reducing moisture level. In one or more embodiments, if the system may be operated in the waste gas elimination cycle or the carbon capture cycle, at least a unit controller 124 may generate command signal 120 to activate a vacuum pump. Command signal 120 may be transmitted to at least a first level control circuit 116 to adjust the internal pressure of the system accordingly.

With continued reference to FIGS. 1A-B, at least a unit controller 124 may be configured to have information on current situation of at least a system component 104. In one or more embodiments, current situation may include, but is not limited to: the status of valves controlled by the valve actuator; the internal temperature of the system controlled by the temperature control system; the carbon dioxide concentration within the system measured by the carbon dioxide sensor; the moisture level within the system measured by the moisture sensor; the sealing status of the system controlled by the air intake and outlet mechanisms; the internal pressure of the system controlled by the vacuum pump; and the operational effectiveness of the carbon capture determined by the current status of carbon capture material.

With continued reference to FIGS. 1A-B, system 100a-b may further include a master controller 118 configured to control at least a first level control circuit 116. A “master controller 118,” as used in this disclosure, is a central supervisory unit within a distributed control architecture configured to oversee, coordinate, and/or direct the operations of at least another controller, thereby enabling system-wide decision making. In one or more embodiments, at least a unit controller 124 may be controlled by a master controller 118. In one or more embodiments, a master controller 118 may be configured to track the states of at least a unit controller 124. In one or more embodiments, a master controller 118 may generate command signal 120 to instruct state changes in at least a unit controller 124. In one or more embodiments, at least a unit controller 124 may control individual carbon collection chambers, while a master controller 118 may control all carbon collection chambers within system 100a-b. In one or more embodiments, a master controller 118 may be informed of the current states of all carbon collection chambers within system 100a-b. In one or more embodiments, a master controller 118 may maintain information regarding the overall carbon dioxide collection target and generate at least a command signal 120 to at least a unit controller 124 to initiate operation of carbon collection chambers within a predefined time frame or until a specific carbon dioxide capture target is achieved. In one or more embodiments, a master controller 118 may collect and analyze current energy consumption data and adjust carbon dioxide collection goals accordingly to optimize system operation for cost-effective carbon dioxide capture. In one or more embodiments, a master controller 118 may maintain information on the operational status of each carbon collection chamber and, upon detecting a malfunction or breakdown, may generate a command signal 120 indicating a need for repair or maintenance. In one or more embodiments, a master controller 118 may be configured to detect or diagnose equipment malfunctions and generate a command signal 120 to end-users about the source or nature of the errors. In one or more embodiments, a master controller 118 may be configured to activate redundant equipment or components to compensate for the malfunctioning equipment until repair service can be performed. In one or more embodiments, a master controller 118 may reboot at least a unit controller 124 and/or at least a first level control circuit 116. In one or more embodiments, a master controller 118 may be configured to send a RESET signal to at least a unit controller 124 and/or at least a first level control circuit 116 of carbon capture systems to force system 100a-b back into a default operational state. In one or more embodiments, a master controller 118 may selectively deactivate one or more carbon collection chambers to conserve energy or prevent system operation from exceeding a predefined operational cost threshold. In one or more embodiments, a master controller 118 may instruct at least a unit controller 124 to transition through a sequence of states, such as from the carbon capture cycle to the waste gas elimination cycle and subsequently to the carbon collection cycles.

In one or more embodiments, a master controller 118 may be configured to receive inputs from an end user via a human-machine interface (HMI), which may include a monitor, graphical user interface (GUI), or computer-based control panel. In one or more embodiments, the HMI may be implemented through a local terminal or a remotely connected device using a wired or wireless communication link, such as Ethernet, USB, Wi-Fi, or a secured internet connection. In one or more embodiments, end user may monitor states of system 100a-b, including real-time data such as chamber states, carbon dioxide concentration levels, energy usage, and maintenance alerts. In one or more embodiments, end user may send command signal 120 to a master controller 118. For example, without limitation, command signal 120 may include initiating or stopping specific carbon collection cycles, adjusting at least a system parameter 128, modifying operational schedules, or acknowledging system alerts. In one or more embodiments, a master controller 118 may be further configured with access control protocols to restrict end user permissions based on predefined roles and may log end user interactions for system auditing and diagnostics.

With continued reference to claim 1, a master controller 118 may be configured to communicate with a remote device 122. A “remote device,” as used in this disclosure, is a device that enables an end user or an external system to remotely monitor or interact with another device or system from a distance. In one or more embodiments, a master controller 118 may be configured to communicate with a remote device 122 through a wired or wireless communication interface. For example, without limitation, communication interfaces may include Ethernet, Wi-Fi, or cellular networks. In one or more embodiments, a remote device 122 may include a cloud server, a mobile application, a remote monitoring terminal, or a centralized Supervisory Control and Data Acquisition (SCADA) system. In one or more embodiments, a master controller 118 may store system-related database information on a cloud server. In one or more embodiments, the cloud server may be configured to compare operational data from current system with data from other types of carbon capture systems, thereby generating analytical results for optimizing the current system. In one or more embodiments, a master controller 118 may utilize machine learning algorithm implemented on the cloud server, thereby reducing local computational load and enabling overall system performance. In one or more embodiments, end users may employ a remote device 122 to access and review system status, carbon dioxide collection data, operational alerts, energy usage metrics, and maintenance diagnostics.

Referring now to FIGS. 1A-BA, an exemplary embodiment of an active carbon capture system with a distributed control architecture 100A is illustrated. System 100A shows a master controller 118 communicatively connected to a plurality of unit controllers 112a through 112n and a remote device 122. Each unit controller 112a through 112n is communicatively connected to at least a first level control circuit 116, wherein each first level control circuit 116 is communicatively connected to a corresponding set of system components 104 comprising a valve actuator, a fan, a vacuum pump, a temperature control system, a sensor, and a carbon capture material.

Referring now to FIGS. 1A-BB, an exemplary embodiment of an active carbon capture system with a distributed control architecture 100B is illustrated. System 100B shows at least a system component 104 configured to receive a control signal 108 and perform a carbon capture action 112, at least a first level control circuit 116 communicatively connected to the at least a system component 104 and configured to receive a command signal 120 and transmit the control signal 108 to the at least a system component 104 as a function of the command signal 120, and at least a unit controller 124 communicatively connected to the at least a first level control circuit 116 and configured to detect at least a system parameter 128, generate the command signal 120 as a function of the at least a system parameter 128, and transmit the command signal 120 to the at least a first level control circuit 116.

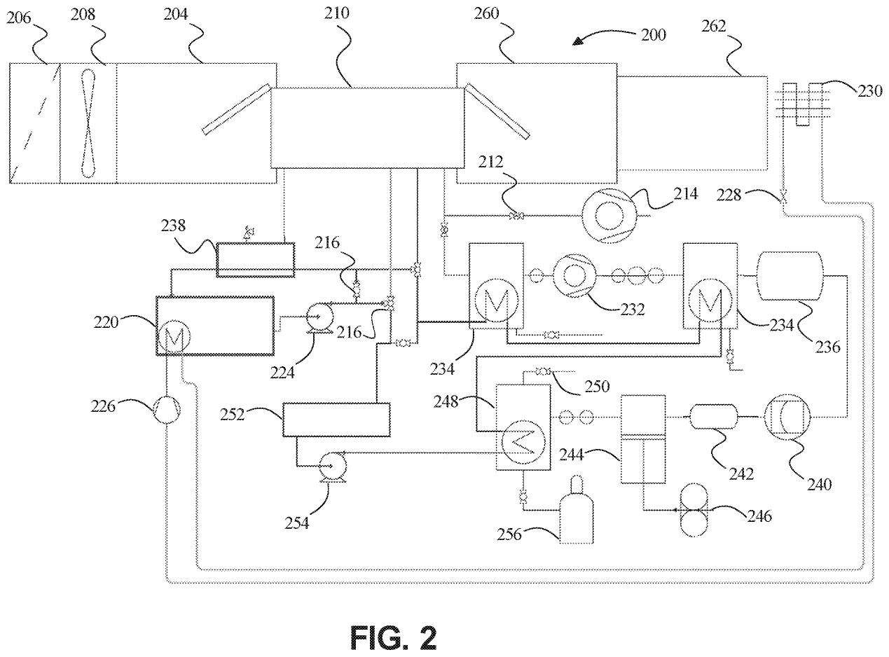

Referring now to FIG. 2, another exemplary embodiment of a direct air capture system 200 is described. In one or more embodiments, direct air capture system may be consistent with an active carbon capture system 100a-b as described in reference to at least FIGS. 1A-B. In one or more embodiments, direct air capture system (DAC) 200 may include an example embodiment of a plurality of exemplary embodiments of carbon capture system 100a-b. In one or more embodiments, DAC system 200 may include a temperature-vacuum swing adsorption process, with an intermittent steam sweep, and an amine-functionalized polymer sorbent. The sorbent may include, but is not limited to, Lewatit VP OC 1065. While a number of contactors may run in parallel in a batch process at larger scales, DAC system 200 may operate a single contactor in a batch process. In one or more embodiments, DAC system 200 may be placed in between a data center's fans and filters, and the computing units themselves, drastically driving down the cost and energy consumption of airflow for the direct air capture system 200.

With continued reference to FIG. 2, an integration of DAC system 200 with a data center may provide additional heat as a resource for desorption. In one or more embodiments, DAC system 200 may utilize resistive heating. In one or more embodiments, carbon capture system may include air-sourced heat pumps that will allow for a reduction in heating energy. Along with the benefits of shared airflow and waste heat, there are business model advantages of the integrated system, which may increase a profitability of DAC system 200.

With continued reference to FIG. 2, DAC system 200 may include an inlet plenum 204. An “inlet plenum,” for the purposes of this disclosure, is a chamber that facilitates the distribution of incoming air or gas into a carbon capture system. For example, and without limitation, inlet plenum may facilitate the even distribution of air into a carbon capture chamber in order to reduce turbulence. In one or more embodiments, inlet plenum 204 may serve as a buffer zone to allow for incoming air to spread evenly through a chamber before entering a carbon capture chamber, such that the air may be evenly distributed amongst adsorbent and/or absorbent materials within a carbon capture chamber. In one or more embodiments, an air intake system as described in reference to at least FIGS. 1A-B, may include an even distribution of airflow or air pressure due to the use of turbines and/or fans. In one or more embodiments, inlet plenum 204 may serve as a buffer zone, such that air may flow evenly and/or contain minimal pressure differential prior to entering carbon capture chamber. In one or more embodiments, air within inlet plenum may be received from an air intake system as described in reference to at least FIGS. 1A-B. In one or more embodiments, air intake system may include an inlet air filter 206 that is configured to filter out dust and/or other particles that may reduce an efficiency of DAC system 200. In one or more embodiments, the filter 206 may be configured to allow only substances in a gaseous state to pass through. In one or more embodiments, air intake system may further include a primary fan 208 to pull air through filter 206 and into inlet plenum. In one or more embodiments, air may include air expelled from an exhaust system, wherein flowing air from an exhaust system may travel through filter 206 and into inlet plenum 204.

With continued reference to FIG. 2, DAC system 200 includes a capture chamber 210. In one or more embodiments, capture chamber 210 may include any carbon capture chamber as described in this disclosure. In one or more embodiments, capture chamber 210 may be configured to receive air from inlet plenum 204 and facilitate an adsorption and/or desorption process. In one or more embodiments, DAC system 200 may include a plurality of capture chambers 210, wherein the plurality of capture chambers 210 may facilitate a continuous receipt of air from an exhaust system.

With continued reference to FIG. 2, DAC system 200 includes one or more contactors. In one or more embodiments, one or more contactors may be located within capture chamber 210. A “contactor,” for the purposes of this disclosure, is a device configured to facilitate the interaction between a gas and a capture medium. For example, and without limitation, contactor may facilitate an interaction of gas and adsorbent and/or absorbent material in order to capture carbonic substance. In one or more embodiments, the contactors are composed of aluminum and copper convective heating elements that may be coated in Lewatit sorbent. In one or more embodiments, contactors may be 14 inches tall. In one or more embodiments, contactors may be 6 feet tall. For a 520 ton/yr system, DAC system 200 may include 35 of these contactors in a multi-stream batch configuration, which will approximate to 5 streams, each with 7 contactors running in parallel. These contactors may include parallelized heating/cooling channels made of copper and may be connected through a custom manifold system. The contactors may be “structural” and wrapped with a thin shell of stainless steel, which acts as the vacuum chamber. Vacuum forces are opposed by the coolant channels in one direction, and by the fins in the other direction. This approach allows a vacuum chamber's costs to be drastically reduced and allows one to use approximately 1/10th the volume of material that would be required if we built a traditional vacuum chamber that was self-supporting. A thin wall of the vacuum envelope is welded to a larger stainless-steel frame at each end, which provides support for the vacuum doors and locations for vacuum lines, coolant passthroughs, and electrical passthroughs. In one or more embodiments, contactors may include adsorbent and/or absorbent material as described in reference to at least FIGS. 1A-B. In one or more embodiments, contactors may include fins as described in reference to at least FIG. 2.

In one or more embodiments, adsorbent and/or absorbent material may include a sorbent. In one or more embodiments, the sorbent may include Lewatit VP OC 1065, which is an amine-functionalized divinylbenzene crosslinked polymer that comes in a spherical bead form. In one or more embodiments, the sorbent is adhered to aluminum fins on the contactor by dip-coating the contactor in an adhesive bath and then dipping the contactor into a bath of sorbent particles.

With continued reference to FIG. 2, DAC system 200 includes an adsorption system. In one or more embodiments, adsorption system may facilitate the adsorption of carbonic substance as described in reference to at least FIGS. 1A-B. In one or more embodiments, airflow enters DAC system 200 through an array of MERV-6 filters (e.g., filters 206), which helps to prevent dust and other particulate matter from entering the system. Next, ambient air passes through an array of fans (e.g., primary fan 208), which operate across a pressure drop of approximately 2 inches of water. The air may then flow into an intake plenum 204 before flowing through the open vacuum doors of capture chamber 210. The velocity of the air between the fins may be around 4 m/s, although this velocity can be ramped up or down depending on energy costs, carbon dioxide costs, weather conditions, or other factors in order to optimize the production or profitability of the system. After passing through the contactor and having the carbon dioxide extracted, the air flow may continue to enter from the data center and into DAC system 200. The data center may be filled with graphics processing units (GPUs), which are rented out on cloud platforms. From the perspective of the carbon capture system, these act as a “black box” that provides waste heat and requires significant amounts of airflow. By placing the data center inside the DAC system 200, there are significant savings due to shared capital costs and operating costs. Separately, the two systems would require two sets of fans and filters. There are also substantial savings due to the sharing of power electronics, building and construction costs, civil engineering, sighting, permitting, and other infrastructure. This shared infrastructure helps to drive down the cost of DAC system 200, effectively using the data center to subsidize the cost of DAC system 200, while also providing waste heat and reduced fan energy costs due to the shared filtration. There are also significant business model synergies which are further described in this disclosure. After air flows through the data center and is warmed, the carbon dioxide (e.g., carbonic substance) flows through the evaporator side of an air-sourced heat pump. The heat pump and waste heat from the data center greatly reduce the energy consumption required to regenerate the sorbent. After exiting the evaporator, the airflow exits the system entirely. In one or more embodiments, additional climate control systems may not be needed in order to keep temperatures or humidities within operational bounds when the system is operated in a moderate climate. In one or more embodiments, adsorption system may include adsorbent and/or absorbent materials as described in this disclosure, such as contactors, fins, and/or the like.

With continued reference to FIG. 2, DAC system 200 includes a desorption system. Once the sorbent (e.g., adsorbent and/or absorbent material) has adsorbed a sufficient amount of carbon dioxide, the vacuum chamber doors close, and a pump valve 212 opens to a purge vacuum pump 214. This purge vacuum pump 214 may include a rotary screw pump and may be responsible for pumping down the capture chamber 210 as quickly as possible to remove the atmospheric gases before carbon dioxide is desorbed. A separate pump may be required so that the product carbon dioxide stream is not continually contaminated with excess nitrogen, oxygen, etc. In one or more embodiments, purge vacuum pump 214 may include and/or be included within vacuum system as described in this disclosure. In one or more embodiments, purge vacuum pump 214 may be configured to extract air within capture chamber, wherein the air now lacks at least some carbon dioxide which has been adsorbed within capture chamber 210. In one or more embodiments, purge vacuum pump may be fluidly connected to capture chamber 210 through pipes and/or lines that allow for air to be sucked from capture chamber. In one or more embodiments, pump valve 212 may open and/or close a connection between purge vacuum pump and capture chamber 210, such that when pump valve 212 is open, purge vacuum pump may be configured to extract air from capture chamber. In one or more embodiments, purge vacuum pump may extract air and/or gas and expel air into surround atmosphere.

Once the capture chamber 210 is down to approximately 20 torr, hot water valves 216 may open to allow hot water to rush into the contactor's heating lines, rapidly heating the contactor. These hot water lines may be consistent with heat exchanger as described in reference to at least FIGS. 1A-B. In one or more embodiments, hot water valves 216 may allow for water to flow from a hot tank 220 holding hot water. In one or more embodiments, a heat pump 224 may be used to flow hot water from hot tank 220 and through water valves 216 and into capture chamber 210. In one or more embodiments, the introduction of heat, such as hot water, may increase molecular activity and result in carbon dioxide being desorbed from adsorbent and/or absorbent material. In one or more embodiments, during an initial stage of heating capture chamber 210, the first material to be desorbed from the sorbent is water, and so the purge vacuum pump 214 remains connected for several seconds to allow for this water to be removed from the system and to reduce the condensing load on the system. Then the pump valve 212 may be closed such that carbon dioxide may be desorbed and float freely within capture chamber 210. In one or more embodiments, water, and/or a fluid within hot tank 220 may be heated using a heat pump compressor 226. In one or more embodiments, the heat pump compressor 226 may pressurize a refrigerant gas and thus significantly increase the temperature of the refrigerant gas. The high temperature and high-pressure refrigerant may then move to a condenser coil with hot tank 220 and heat a liquid, such as water, within hot tank 220 using conduction. In one or more embodiments, hot tank 220 may operate at a temperature of 90 to 95 degrees Celsius. The refrigerant may then be cooled due to the heat transfer from the refrigerant to the liquid within hot tank 220. The refrigerant may then be transferred to an expansion valve 228, wherein the expansion valve 228 may reduce a pressure of the refrigerant and thus drop the temperature of the refrigerant as well. Following use of the expansion valve, the refrigerant may include a low pressure and low temperature refrigerant. The refrigerant may then pass through one or more heat exchanger coils 230, such that the refrigerant may absorb heat from a surrounding atmosphere and increase in heat. The refrigerant, now containing an ambient temperature and low pressure, may then be transferred back to the heat pump compressor 226 to be compressed into a high temperature and high-pressure refrigerant for use in hot tank in a subsequent cycle of carbon capture.

With continued reference to FIG. 2, shortly after hot water begins flowing through capture chamber 210, the purge vacuum pump 214 may be closed off from the system and an extraction pump 232 may be connected. In one or more embodiments, extraction pump 232 may include a pump configured to extract carbon dioxide from capture chamber 210. In one or more embodiments, following purge of air from capture chamber 210, a desorption process may begin wherein carbon dioxide is desorbed from adsorbent and/or absorbent material and suspended within carbon capture chamber. Extraction vacuum pump 232 may then be used to extract carbon dioxide from capture chamber 210. For a 520 ton/yr system, the extraction pump 232 may be a rotary screw pump, such as a Leybold DV1200 or two DV650s. It is imperative that these pumps are hermetically sealed in order to avoid contamination of the carbon dioxide product. Shell and tube condensers 234 may be located both before and after the extraction pump 232, which greatly reduces the gas volume that is required to be pumped. These condensers 234 may run at 5 °C, along with a liquid carbon dioxide condenser 248. After the product carbon dioxide is brought to atmospheric pressure, it flows into an intermittent buffer vessel 236, which may include a gas bag. Gas bags have certain advantages over pressure vessels, such as always operating at atmospheric pressure, which simplifies instrumentation and control processes, and extends the life of the vacuum pump. In one or more embodiments, intermittent buffer vessel 236 may include a container as described above. In one or more embodiments, carbonic substance, such as CO2, may be placed in intermittent buffer vessel 236 following carbonic cycle.

In one or more embodiments, desorption system may include an addition of a steam sweep gas through the latter portions of the desorption cycle, which helps to reduce the partial pressure of carbon dioxide in the vacuum chamber and accelerate the desorption process. DAC system 200 may include a steam generator 238 that allows for intermittent injection of steam into capture chamber 210, which may allow for implementation of any improvements to DAC system 200.

In one or more embodiments, DAC system 200 may allow for the sequestration of carbon dioxide underground and to sell carbon credits to slow or reverse the effects of climate change and global warming. In one or more embodiments, DAC system 200 may further be used to make beverage-grade carbon dioxide that can be re-used for a wide variety of purposes. Once the carbon dioxide is in a buffer vessel, it is compressed using a carbon dioxide compressor 240 to approximately 100 PSI to 125 PSI. This pressure may be chosen because the equipment is widely available and can tap into the compressed air industry's equipment for things like filters, desiccants, air lines, fittings, and more. The compressed carbon dioxide passes through a desiccant bed 242 (e.g., Sorbead Air WS) to strip out any remaining water in the system, dropping the dew point to below −50 °C, allowing one to meet the requirements for ISBT beverage grade. Compressed air may feed into a pressure amplifier 244, such as a Haskel Q-drive gas compressor, exiting at around 750 PSI. An air compressor 246 may be used to increase the pressure of the pressure amplifier 244. The air compressor 246 may drive a piston to compress the carbon dioxide into a smaller volume and thereby increase pressure. The compressed carbon dioxide may increase in temperature as an increase in pressure may result in an increase in pressure. The compressed carbon dioxide may pass through a carbon dioxide condenser 248 to cool the pressurized carbon dioxide, such that the carbon dioxide decreases in temperature while still maintaining a high pressure. The condensed carbon dioxide may include carbon dioxide in a pressurized liquid form. As the carbon dioxide condenses, any impurities may reside in a head space, which is periodically purged through a purge valve 250. The carbon dioxide condenser may cool the carbon dioxide using liquid from a cold tank 252. The cold tank 252 may include chilled liquids and/or gases. The cold tank 252 may include a liquid at 5 degrees Celsius. The cold tank 252 may supply cooled fluid to multiple condensers and/or cooling systems of DAC system 200 using a cold pump 254. In one or more embodiments, cold tank 252 may supply a cooled liquid to capture chamber 210 in order to cool down capture chamber and prepare capture chamber 210 for subsequent receipt of air. The carbon dioxide that condenses flows to the bottom of the column, and then periodically empties into a holding tank 256, from which beverage-grade carbon dioxide is distributed.

With continued reference to FIG. 2, in one or more embodiments, DAC system 200 may include an outlet plenum 260. An “outlet plenum,” for the purposes of this disclosure, refers to a chamber that is connected to an outlet of a capture chamber. In one or more embodiments, gas may flow through inlet plenum 204 and out through outlet plenum 260 during an initial adsorption phase, such that air passes through carbon capture chamber and carbon dioxide is extracted from the air and adsorbed to the adsorbent and/or absorbent material. In one or more embodiments, outlet plenum 260 may facilitate the outflow of air once air has passed through capture chamber 210. In one or more embodiments, outlet plenum 260 may facilitate the movement of air in which carbon dioxide has been extracted. In one or more embodiments, once carbon dioxide has been fully adsorbed, carbon capture chamber 210 may be sealed from input plenum and output plenum, wherein purge vacuum pump 214 may extract any residual air that remains within capture chamber 210.

With continued reference to FIG. 2, energy consumption of DAC system 200 may be in the range of 800 kWh/ton-1000 800 kWh/ton of carbon dioxide. The efficiency gains at this step are largely due to improvements in component efficiency, reduction in thermal mass, and reduction of parasitic energy losses. There are still substantial energy efficiency savings that remain, and that will be pursued with increased scale. In one or more embodiments, vacuum pumping may be performed in multiple stages, with additional moisture removal between each step, which greatly reduces pumped volume and increases efficiency. Large numbers of contactors allow for improved staging, which allows the system to operate more like a continuous process rather than many batches. This improvement in staging allows for equipment to be run more often at its point of maximum efficiency and will also help to improve equipment longevity. A substantial improvement in energy efficiency can be achieved by reducing the energy consumed for heating and cooling the contactors. In one or more embodiments, the largest source of energy consumption in DAC system 200 may include the heat exchanger, such as heat pump. Improving the utilization of waste heat from the data center can drastically cut this energy consumption. The addition of multiple temperature stages can also help to reduce the energy consumption substantially, i.e., by maintaining a medium-temperature tank of water that can be used to both increase the temperature of contactors at the beginning of the desorption cycle and can be used to rapidly bring the temperature of hot contactors back toward room temperature.

With continued reference to FIG. 2, DAC system 200 may include custom-built contactors, rather than relying on off-the-shelf contactors that are sourced from local radiator manufacturers. A custom design will allow for improved tube spacing, fin spacing, and reduction in thermal mass, which can help to reduce the thermal energy loads on the system. Current contactor designs may utilize the Lewatit VP OC 1065 powder as it comes from the manufacturer, with one drying step before coating takes place. In one or more embodiments, separation of the particles by size and optimization of size distribution that gets used on contactors may increase efficiency. Large particles have the greatest capacity for carbon dioxide adsorption but also require longer times for carbon dioxide to diffuse to the interior of the particle. By optimizing the particle size distribution, DAC system 200 can reduce the energy consumption and improve the kinetics of the system by optimizing the capacity of the particles vs. their thermal mass.

With continued reference to FIG. 2, DAC system 200 may be controlled by a DAC control system 262. In one or more embodiments, DAC control system 262 may include a controller as described in reference to at least FIGS. 1A-B. A provocative DAC control system 262 is a networked system split into several components: module, rack, and infra. Modules are groupings of carbon dioxide DAC contactor assemblies that are controlled together by one module board. Racks are groupings of modules that are controlled and sequenced by one rack board. Infra are groupings of supporting infrastructure components, such as heat pumps, compressors, etc. The control system communications network follows a hub-and-spoke topology. Application code running on a computer (the “hub”) communicates with CANbus networks (the “spokes”) containing rack and infra nodes. Each rack then contains a single linear CANbus network containing module nodes.

With continued reference to FIG. 2, all valves in DAC system 200 may be controlled via pneumatics, which helps to decrease costs and simplify control. Each contactor has water lines in and out, a vacuum line out, a steam line in, and an auxiliary port for other sensors inside the vacuum chamber, such as thermocouples or other sensors that may be added as needed. Each stage of contactors running together requires a hot water and cold-water inlet and outlet valve, a steam on/off valve, a purge vacuum valve, an extraction vacuum valve, and electrical lines for sensors. Each stage of contactors requires water temperature sensing, vacuum pressure sensing, and carbon dioxide concentration sensing at the outlet, which can also be paired with air temperature and humidity sensing for low cost. Many of the additional sensors are shown above in and mainly include sensors for pressure and temperature. Additional sensors include carbon dioxide concentration sensors, flow meters, dew point sensors, and differential pressure sensors.

With continued reference to FIG. 2, Power for DAC system 200 may be sourced from the local grid, with the potential to integrate on-site solar and batteries.

### Detailed State-Point Diagram

With further reference to the particular implementation, the system described in reference to at least FIGS. 1A-B and FIG. 2 has been modeled and simulated, for instance and without limitation in Python. A mass and energy balance has been conducted, with results posted below. Contactor kinetics have also been simulated using a finite-difference approach, with sorbent capacity modeled using a temperature-dependent Toth model (2). The results for the model are described in Table 1 below.

TABLE 1
State point properties, with state points correlating
to the diagram shown in at least FIGS. 1A-B and FIG. 2

| | | | | | | | | | mass | mole |
|---|---|---|---|---|---|---|---|---|---|---|
| | | | mass | volumetric | | | | | fraction | fraction |
| State | Temp | Pressure | flow | flow | enthalpy | entropy | density | relative | carbon | carbon |
| point | (°C) | (Pa) | (kg/s) | (m³/s) | (J/kg) | (J/kg) | (kg/m³) | humidity | dioxide | dioxide |
| 0 | 25 | 101325 | | | 44949 | 161.5 | 1.18 | 40 | | |
| 1 | 25 | 101325 | 57.58 | 48.85 | 44949 | 161.5 | 1.18 | 40 | | |
| 2 | 25 | 101213 | 57.58 | 48.904 | 44972 | 161.9 | 1.18 | 40 | | |
| 3 | 26 | 101695 | 57.58 | 48.776 | 45522 | 162.4 | 1.18 | 38.5 | | |
| 4 | 31 | 101445 | 57.56 | 49.685 | 49608 | 176.5 | 1.16 | 27.3 | | |
| 7 | 35 | 101375 | 57.56 | 50.507 | 54473 | 192.5 | 1.14 | 20.8 | | |
| 8 | 35 | 101325 | 57.56 | 50.46 | 54028 | 191.2 | 1.14 | 21.3 | | |
| 14 | 85 | 6666 | 0.0549 | 0.89 | 1431803 | 5749.6 | 0.06 | | 0.585 | 0.366 |
| 15 | 5 | 7333 | 0.0339 | 0.261 | 595877 | 3506.2 | 0.13 | | 0.948 | 0.881 |
| 16 | 258 | 101325 | 0.0339 | 0.036 | 845731 | 3604.6 | 0.94 | | 0.948 | 0.881 |
| 17 | 5 | 101325 | 0.0322 | 0.017 | 496155 | 2702.5 | 1.93 | | 0.996 | 0.991 |
| 18 | 180 | 700000 | 0.0322 | 0.004 | 653705 | 2774.6 | 8.2 | | 0.996 | 0.991 |
| 20 | 5 | 700000 | 0.0321 | 0.0023 | 482267 | 2296.2 | 13.95 | | 1 | 1 |
| 21 | 186 | 5000000 | 0.0321 | 0.0005 | 635548 | 2365.1 | 60.74 | | 1 | 1 |
| 22 | 14 | 5000000 | 0.0321 | | | | | | 1 | 1 |
| 30 | 5 | 7333 | 0.021 | 2.10E−05 | 26 | 76.3 | 999.92 | | | |
| 31 | 5 | 101325 | 0.0017 | 1.66E−06 | 21120 | 76.3 | 999.97 | | | |
| 32 | 5 | 700000 | 9.77E−05 | 9.76E−08 | 21716 | 76.2 | 1000.26 | | | |

Key equipment parameters may be determined using a model and/or simulation and can be illustrated and described in a table below. The power consumption of the major equipment results in an overall power consumption of 153 kW, or just over 1320 kWh/ton of carbon dioxide. The results are described in Table 2 below.

TABLE 2
Major equipment power consumption

| Major | | Power | | Tentative |
|---|---|---|---|---|
| component | Efficiency | consumption | | equipment |
| Vacuum pump | ηₛ = 75% | 9 | kW | Leybold DV |
| | | | | 650 x2 |
| Compressor | ηₛ = 75% | 5.4 | kW | Atlas Copco G5 |
| Pressure Amplifier | ηₛ = 80% | 4.9 | kW | Haskel HGD-150 |
| Fan | ηₛ = 75% | 21 kW (DAC share) | | Hartzell 03U0-15- |
| | | | | BU100BN x3 |
| Chiller | COP = 4 | 19.3 | kW | York YCAL |
| Heat Pump | COP = 3 | 82.3 | kW | Solid energy |
| | | | | LW80IB |

With further reference to the particular implementation, the system described in reference to at least FIGS. 1A-B and FIG. 2 may be modeled and/or simulated. A mass and energy balance has been conducted, with results posted below. Contactor kinetics have also been simulated using a finite-difference approach, with sorbent capacity modeled using a temperature-dependent Toth model (2).

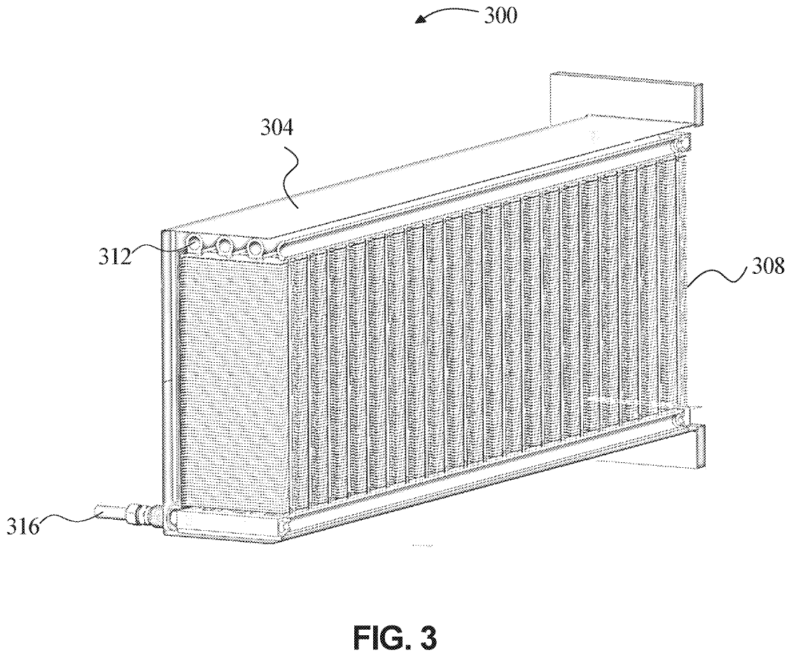

Referring now to FIG. 3, an exemplary embodiment of a cross-sectional view of a carbon capture chamber 300 is described. In one or more embodiments, carbon capture chamber may also be referred to as a “vacuum chamber.” In one or more embodiments, carbon capture chamber 300 may serve as an active carbon capture system, wherein carbon capture chamber 300 may be configured to adsorb carbonic substances such as carbon dioxide. In one or more embodiments, a gas such as air is blown through the carbon capture chamber 300. In one or more embodiments, carbon capture chamber may include one or more walls 304 that are used to provide a structure to carbon capture chamber 300. In one or more embodiments, walls 304 may ensure that carbon capture chamber 300 is capable of providing a sealed environment from the atmosphere. In one or more embodiments, walls 304 may provide structural rigidity such that carbon capture chamber does not collapse or buckle under negative pressure. In one or more embodiments, carbon capture chamber may be similar to that of a container, wherein walls 304 may provide the structure of the container. In one or more embodiments, walls may be made of a structurally rigid material such as aluminum, copper, a metal, a metal alloy, and/or the like. In one or more embodiments, walls 304 may be made of thermally conductive materials in order to facilitate a heat transfer between an inside of carbon capture chamber 300 and an outside of carbon capture chamber 300.

The carbon capture chamber may include a plurality of fins 308 made of a thermally conductive material, such as any thermally conductive material as described in this disclosure. In one or more embodiments, a plurality of fins 308 may include and/or be included in a material body as described in reference to at least FIGS. 1A-B. In one or more embodiments, a plurality of fins 308 may include a thermally conductive material such as any material as described in this disclosure which contains thermal properties capable of transferring heat. In one or more embodiments, the thermally conductive material may be covered and/or coated with an adsorbent and/or absorbent material that carbon dioxide will attach to at a low temperature. In one or more embodiments, the thermally conductive material may provide for efficient heat transfer between the adsorbent and/or absorbent material and the thermally conductive material in order to facilitate an adsorption or desorption process. In one or more embodiments, once the carbonic substances are adsorbed to the adsorbent and/or absorbent material, the air may be sucked out of carbon capture chamber using a vacuum system such as any vacuum system as described in this disclosure. The vacuum system may expel any air within carbon capture chamber 300 while leaving the carbonic substances which remain adsorbed to the adsorbent and/or absorbent material. In one or more embodiments, a plurality of fins 308 may be heated up in order to facilitate a desorption process. In one or more embodiments, air may transfer through fins, wherein carbonic substances may adsorb to a surface of fins during the transfer. In one or more embodiments, fins 308 may include adsorbent and/or absorbent material as described in reference to at least FIGS. 1A-B. In one or more embodiments, fins may provide for increased surface area between air passing through carbon capture chamber 300. In one or more embodiments, fins may include substantially planar surfaces in which air passes through and adsorbs to a surface of fins 308. In one or more embodiments, fins 308 may include a plurality of sheets stacked above one another and spaced evenly to allow for air to pass through the sheets. In one or more embodiments, fins 308 may include a structurally rigid material such as a metal or metal alloy in order to contain a pressure within carbon capture chamber 300. In one or more embodiments, fins may include substantially planar sheets that allow for maximum surface area contact between air and an adsorbent and/or absorbent coating on fins 308. In one or more embodiments, heating of the fins 308 will allow for heat to transfer to adsorbent and/or absorbent material and thereby cause increased molecular activity which will result in the desorption of carbonic substance from adsorbent and/or absorbent material. In one or more embodiments, fins 308 may be heated by pumping hot water through pipes thermally connected to a plurality of fins 308. This process may release carbon dioxide into the surrounding atmosphere of the carbon capture chamber. In one or more embodiments, a second vacuum is then used to expel the carbonic substances in the carbon capture chamber. In one or more embodiments, following desorption, the carbonic substances may be suspended in a gaseous format, where a vacuum may be used to retrieve the gaseous format from the chamber. In one or more embodiments, following removal of carbonic substances, a plurality of fins 308 may be cooled (e.g., using cold water and/or a heat exchanger as described in this disclosure) and carbon capture chamber 300 is repressurized and/or reopened in order to accept new air and restart the carbonic cycle.

With continued reference to FIG. 3, in one or more embodiments, fins 308 may extend laterally across carbon capture chamber from an inlet to an outlet. In one or more embodiments, the inlet may be defined as the location at which air and/or gas enters carbon capture chamber, wherein outlet may be defined as the location at which air or gas leaves carbon capture chamber.

With continued reference to FIG. 3, a system as described in reference to FIGS. 1-2 may utilize multiple chambers, permitting some carbon capture chambers to run adsorption cycles while others are desorbing (pulling vacuum). Such a process would allow continuous airflow. In addition, such a process would allow for individual modules (also referred to as “individual carbon capture chambers”) to be taken offline for repair or swapped with replacements while the system continues to operate. Downstream, the carbon dioxide may be further purified by removing water vapor and then cooled to form liquid or pumped into pressurized tanks. The whole system can be integrated into a datacenter that uses air (at least partially) to cool servers/computers, or any other setup where air has to be moved through for other reasons, such as, but not limited to, an apartment or office buildings with active ventilation/HVAC systems. In one or more embodiments, systems described herein may be implemented and/or integrated into data centers and/or existing devices that utilize airflow in order to remove carbon from the air flowing through said devices.

With continued reference to FIG. 3, carbon capture chamber 300 may include a plurality of tubes 312. In one or more embodiments, tubes may serve as a component of heating element and/or heat exchanger as described in this disclosure. In one or more embodiments, heated gases and/or fluids may flow through a plurality of tubes 312 in order to provide heat to carbon capture chamber 300. In one or more embodiments, carbon capture chamber may be heated through conduction, wherein heat from liquids such as water may heat a plurality of tubes 312 and heat from tubes may be transferred to fins 308. In one or more embodiments, a plurality of tubes 312 and a plurality of fins 308 may contain a thermally conductive material that allows for heat to transfer between a plurality of tubes 312 and a plurality of fins 308. In one or more embodiments, a plurality of tubes 312 may be configured to hold a cooled liquid as well, wherein the cooled liquid may absorb heat from carbon capture chamber and a plurality of fins 308. In one or more embodiments, liquids may flow within a plurality of tubes 312 through the use of a cooling pump and/or a heating pump.

With continued reference to FIG. 3, it may be the case that vacuum chambers require a lot of structural strength, or they risk implosion due to pressure differences caused by the use of a vacuum. Such an implosion may be mitigated through the use of thick sidewalls, reinforcing ribs, and/or particular (e.g., cylindrical) shapes. In one or more embodiments, carbon capture chamber 300 may include a plurality of fins 308 and/or tubes 312 that can both facilitate in the carbonic cycle and simultaneously provide structural support to carbon capture chamber. In one or more embodiments, carbon capture chamber 300 may be designed with much thinner walls that will “suck onto” a plurality of fins 308/a plurality of tubes 312 when the vacuum is pulled and be held there against collapse (transverse) or buckling (longitudinal). In one or more embodiments, the use of a plurality of fins 308 and a plurality of tubes 312 to provide structural support will ensure that the only place where thicker material is needed is at the ends (e.g., the inlet and outlet) of the carbon capture chamber. This can work on any transverse cross-sectional shape, but is especially useful for rectangular cross-sections, which are cheap to make and easy to fill: better for cost-effective and reliable mass production. The walls could be made from the sort of plastic used for vacuum sealing but will probably be metal or a heat-resistant hard plastic.

With continued reference to FIG. 3, both a plurality of fins 308 and a plurality of tubes 312 can provide support for the walls of carbon capture chamber 300. In one or more embodiments, a plurality of fins 308 may provide structural support from side to side, while a plurality of tubes 312 provide structural support perpendicularly to a plurality of fins 308 and from top to bottom. As the vacuum chamber gets bigger and bigger, the walls have to get increasingly thicker. In one or more embodiments, the use of a plurality of fins 308 and a plurality of tubes 312 as structural support for carbon capture chamber may allow for an increase in size of carbon capture chamber without decreasing structural rigidity of carbon capture chamber. In one or more embodiments, a vacuum chamber without internals, such as a plurality of fins 308 and ribs, may collapse when increased in size due to structural deficiencies. In one or more embodiments, a plurality of fins 308 and a plurality of tubes 312 may perform the thermal exchange/adsorption process while providing structural rigidity to carbon capture chamber 300 as well. In one or more embodiments, a plurality of fins 308 may fill the chamber transversely, while a plurality of tubes 312 fill carbon capture chamber 300 vertically, to provide (in a first direction and a second direction) structural integrity against negative pressure.

With continued reference to FIG. 3, carbon capture chamber may include a heat exchanger and/or heating component 316 as described in reference to at least FIGS. 1-2. In one or more embodiments, heating component 316 may include a heat transfer structure. The heat transfer structure may also serve as a structural member contacting the external walls and taking the loads (e.g., by preventing buckling). In one or more embodiments, the heat transfer structure may include any material that is thermally conductive. This may include any material as described in this disclosure. In one or more embodiments, thermally conductive material may further include copper or aluminum. Rails could be anything (aluminum is easy to machine, or stainless, or plastic (able to take high temperatures-like CPVC, nylon, PEAK; 92 C or as low as 50-60 C)). Exterior walls of carbon capture chamber could be stainless, aluminum, or even plastic (could be quite weak, as thin as a plastic bag, such as a high-tensile plastic bag). In one or more embodiments, heating component 316 may include and/or be fluidly connected to tubes 312, wherein a fluid from heating component may flow through tubes 312.

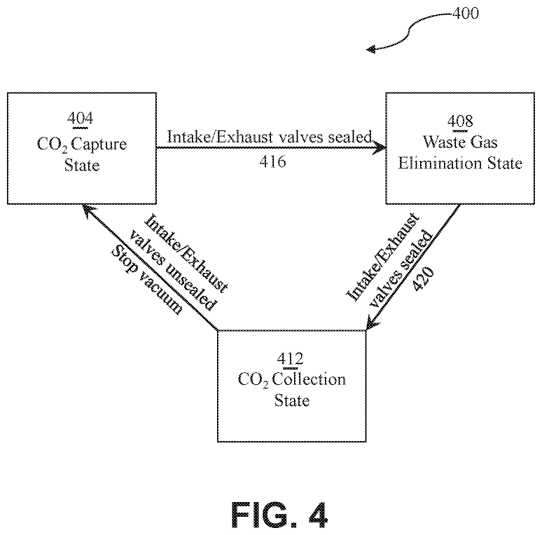

Referring now to FIG. 4, system 100a-b may be incorporated in and/or otherwise combined with dual mode carbon capture chamber as disclosed in U.S. provisional Application No. 63/804,133, filed on May 12, 2025, with attorney docket number 1706-002USP1 and entitled “DUAL MODE CARBON CAPTURE CHAMBER,” the entirety of which is incorporated herein by reference. Dual mode carbon capture chambers may be operated asynchronously, such that at least one chamber operates in the carbon capture state while another chamber operates in the first vacuum mode or the second vacuum mode. In one or more embodiments, asynchronous operation of the plurality of chambers may permit continuous airflow through at least a portion of a carbon capture system while one or more other chambers undergo waste gas elimination, carbon dioxide collection, maintenance, repair, or replacement. In one or more embodiments, dual mode carbon capture chambers may be arranged in parallel fluid paths, such that air is routed through a first chamber operating in the carbon capture state while a second chamber is sealed and operated in the first vacuum mode to remove non-carbon dioxide gas and/or water vapor and while a third chamber is sealed and operated in the second vacuum mode to remove carbon dioxide released from an adsorbent material. In one or more embodiments, one or more valves, dampers, manifolds, fans, ducts, or flow-routing components may be used to selectively direct air to a chamber that is available for carbon capture while isolating another chamber undergoing waste gas elimination or carbon collection. As a non-limiting illustrative example, a carbon capture system may include a first chamber, a second chamber, and a third chamber. During a first time period, the first chamber may receive air through a selectively sealable air intake and operate in the carbon capture state, the second chamber may be sealed and operated in the first vacuum mode to remove non-carbon dioxide gas while carbon dioxide remains adsorbed by an adsorbent material, and the third chamber may be heated and operated in the second vacuum mode to collect released carbon dioxide. During a second time period, the operating states of the first, second, and third chambers may rotate, such that the first chamber enters the waste gas elimination state, the second chamber enters the carbon collection state, and the third chamber is cooled and returned to the carbon capture state. In this manner, dual mode carbon capture chambers may provide substantially continuous carbon capture while individual chambers cycle through adsorption, waste gas elimination, carbon dioxide release, carbon dioxide collection, cooling, maintenance, repair, or replacement.

Within continued reference to FIG. 4, exemplary embodiments of at least one operational state 400 of system 100a-b are illustrated. At least one operational state may be illustrated, for exemplary purposes, as a state machine, transitioning between a carbon dioxide capture state 404, a waste gas elimination state 408, and/or a carbon dioxide collection state 412. In the carbon dioxide capture state 404, both the intake and exhaust valves may be unsealed to allow air to enter chamber. In one or more embodiments, at least a vacuum pump is inactive in the carbon dioxide capture state 404. In one or more embodiments, a temperature control system may be configured to operate in the carbon dioxide capture state 404 under a first mode, wherein the first mode temperature may range from approximately 5 °C to 45 °C for carbon dioxide capture via adsorption and/or absorption. In one or more embodiments, the carbon dioxide outlet is closed during the carbon dioxide capture state 404. In the waste gas elimination state 408, both the intake and exhaust valves may be sealed to retain air within system 100a-b. In one or more embodiments, at least a vacuum pump may be active during the waste gas elimination state 408, operating at a first vacuum power level 416 configured to remove gases other than carbon dioxide through a selectively sealable air exhaust. In one or more embodiments, at least a vacuum pump may operate at a second vacuum power level 420 configured to direct carbon dioxide into carbon dioxide collection system. In one or more embodiments, the temperature control system may be configured to preheat system 100a-b prior to activation of the first vacuum power level 416, thereby removing water vapor before the first vacuum power level 416 is activated. In one or more embodiments, the carbon dioxide outlet is closed during the waste gas elimination state 408. In the carbon dioxide collection state 412, both the intake and exhaust valves may be sealed to retain the released carbon dioxide within system 100a-b prior to its redirection into a carbon dioxide collection system. In one or more embodiments, a temperature control system may be configured to operate in the carbon dioxide collection state 412 under a second mode, wherein the second mode temperature may range from approximately 85 °C to 258 °C for carbon dioxide release. In one or more embodiments, a carbon dioxide outlet may be opened during the carbon dioxide collection state 412 to direct the released carbon dioxide into a carbon dioxide collection system under a second vacuum power level 420. In one or more embodiments, system 100a-b may include a heating system configured to remove water vapor from the carbon dioxide collected from the carbon dioxide collection state 412 before the purified carbon dioxide is directed into one or more pressurized tanks for storage. In one or more embodiments, the carbon dioxide collection chamber may include a cooling system that liquidizes the gaseous carbon dioxide collected from the carbon dioxide collection state 412 for future use. Upon completion of the carbon dioxide collection state 412, both the intake and exhaust valves may be unsealed, and at least a vacuum pump may be deactivated to transition system back into the carbon dioxide capture state 404.

With continued reference to FIG. 4, at least one operational state described herein, including the carbon dioxide capture state 404, waste gas elimination state 408, and carbon dioxide collection state 412, may be incorporated into a machine learning model. A machine learning model may analyze historical and real-time data to determine optimized conditions for each operational state. This optimization may involve adjusting operational parameters such as temperature, vacuum pressure, airflow rates, and cycle duration times based on environmental parameters and energy cost.

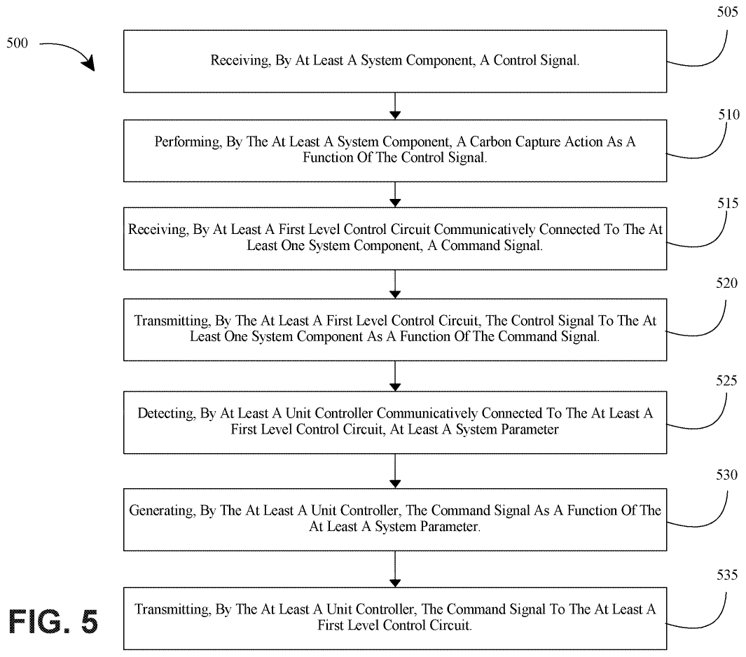

Referring now to FIG. 5, a flow diagram of an exemplary method 500 for controlling an active carbon capture system with a distributed control architecture. At step 505, method 500 includes receiving, by at least a system component, a control signal. This may be implemented as described and with reference to FIGS. 1-4.

With continued reference to FIG. 5, at step 510, method 500 includes performing, by the at least a system component, a carbon capture action as a function of the control signal. This may be implemented as described and with reference to FIGS. 1-4.

With continued reference to FIG. 5, at step 515, method 500 includes receiving, by at least a first level control circuit communicatively connected to the at least one system component, a command signal. This may be implemented as described and with reference to FIGS. 1-4.

With continued reference to FIG. 5, at step 520, method 500 includes transmitting, by the at least a first level control circuit, the control signal to the at least one system component as a function of the command signal. This may be implemented as described and with reference to FIGS. 1-4.

With continued reference to FIG. 5, at step 525, method 500 includes detecting, by at least a unit controller communicatively connected to the at least a first level control circuit, at least a system parameter. This may be implemented as described and with reference to FIGS. 1-4.

With continued reference to FIG. 5, at step 530, method 500 includes generating, by the at least a unit controller, the command signal as a function of the at least a system parameter. This may be implemented as described and with reference to FIGS. 1-4.

With continued reference to FIG. 5, at step 535, method 500 includes transmitting, by the at least a unit controller, the command signal to the at least a first level control circuit. This may be implemented as described and with reference to FIGS. 1-4.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

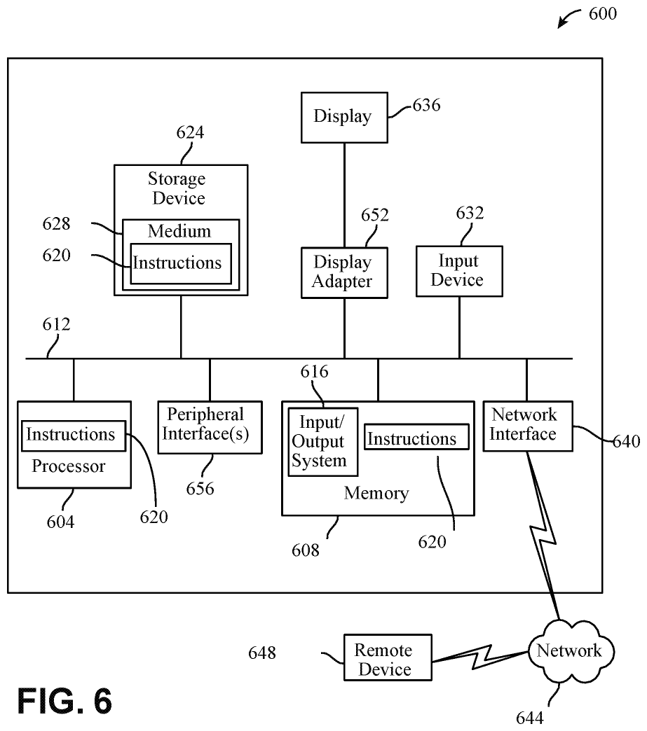

FIG. 6 shows a diagrammatic representation of one embodiment of computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures, including, but not limited to, a memory bus, a memory controller, a peripheral bus, a local bus, and any combinations thereof, using any of a variety of bus architectures.

Processor 604 may include any suitable processor, such as, without limitation, a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display device 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An active carbon capture system with a distributed control architecture, the system comprising:
at least a system component configured to receive a control signal and perform a carbon capture action as a function of the control signal;
at least a first level control circuit communicatively connected to the at least a system component, the at least a first level control circuit configured to receive a command signal and transmit the control signal to the at least a system component as a function of the command signal; and
at least a unit controller communicatively connected to the at least a first level control circuit, the at least a unit controller configured to:
detect at least a system parameter;
generate the command signal as a function of the at least a system parameter; and
transmit the command signal to the at least a first level control circuit.

2. The system of claim 1, wherein the at least a unit controller is configured to operate under a plurality of states, wherein a change between the plurality of states is triggered by detection of the at least a system parameter, and wherein the plurality of states comprises a carbon dioxide capture state, a waste gas elimination state, and a carbon dioxide collection state.

3. The system of claim 2, wherein in the carbon dioxide capture state, the at least a unit controller is configured to open intake and exhaust valves and activate airflow into at least one carbon capture chamber until a predefined carbon dioxide concentration threshold is reached.

4. The system of claim 2, wherein in the waste gas elimination state, the at least a unit controller is configured to seal intake and exhaust valves and activate at least one vacuum pump at a first vacuum power level to remove gases other than carbon dioxide from at least one carbon capture chamber.

5. The system of claim 2, wherein in the carbon dioxide collection state, the at least a unit controller is configured to activate a temperature control system to heat at least one carbon capture chamber and activate at least one vacuum pump at a second vacuum power level to direct released carbon dioxide into a carbon dioxide collection system.

6. The system of claim 1, wherein the at least a unit controller is configured to have information on a current situation of the at least a system component.

7. The system of claim 1 further comprising:
a master controller configured to control the at least a first level control circuit, wherein the master controller is configured to track states of the at least a unit controller; and
command state changes to the at least a unit controller.

8. The system of claim 7, wherein the master controller is configured to communicate with a remote device.

9. The system of claim 1, wherein the at least a system parameter comprises at least one of carbon dioxide concentration, moisture level, temperature, pressure, airflow rate, energy consumption, carbon capture material degradation rate, cycle duration, or system uptime.

10. The system of claim 1, wherein the at least a system component comprises at least one of a valve actuator, a fan, a temperature control system, a vacuum pump, or a plurality of sensors.

11. A method of controlling an active carbon capture system with a distributed control architecture, the method comprising:
receiving, by at least a system component, a control signal;
performing, by the at least a system component, a carbon capture action as a function of the control signal;
receiving, by at least a first level control circuit communicatively connected to the at least a system component, a command signal;
transmitting, by the at least a first level control circuit, the control signal the at least a system component as a function of the command signal;
detecting, by at least a unit controller communicatively connected to the at least a first level control circuit, at least a system parameter;
generating, by the at least a unit controller, the command signal as a function of the at least a system parameter; and
transmitting, by the at least a unit controller, the command signal to the at least a first level control circuit.

12. The method of claim 11, wherein the at least a unit controller is configured to operate under a plurality of states, wherein a change between the plurality of states is triggered by detection of the at least a system parameter, and wherein the plurality of states comprises a carbon dioxide capture state, a waste gas elimination state, and a carbon dioxide collection state.

13. The method of claim 12, wherein in the carbon dioxide capture state, the at least a unit controller is configured to open intake and exhaust valves and activate airflow into at least one carbon capture chamber until a predefined carbon dioxide concentration threshold is reached.

14. The method of claim 12, wherein in the waste gas elimination state, the at least a unit controller is configured to seal intake and exhaust valves and activate at least one vacuum pump at a first vacuum power level to remove gases other than carbon dioxide from at least one carbon capture chamber.

15. The method of claim 12, wherein in the carbon dioxide collection state, the at least a unit controller is configured to activate a temperature control system to heat at least one carbon capture chamber and activate at least one vacuum pump at a second vacuum power level to direct released carbon dioxide into a carbon dioxide collection system.

16. The method of claim 11, further comprising having, by the at least a unit controller, information on current situation of the at least a system component.

17. The method of claim 11 further comprising:
controlling, by a master controller, the at least a first level control circuit, wherein the master controller is configured to track states of the at least a unit controller; and
commanding, by the master controller, state changes to the at least a unit controller.

18. The method of claim 17, wherein the master controller is configured to communicate with a remote device.

19. The method of claim 11, wherein the at least a system parameter comprises at least one of carbon dioxide concentration, moisture level, temperature, pressure, airflow rate, energy consumption, carbon capture material degradation rate, cycle duration, or system uptime.

20. The method of claim 11, wherein the at least a system component comprises at least one of a valve actuator, a fan, a temperature control system, a vacuum pump, or a plurality of sensors.
